(19) United States
(12) Patent Application Publication
(10) Pub. No.: US 2018/0240418 A1
(43) Pub. Date: Aug. 23, 2018

(54) COLOR IMAGE DISPLAY DEVICE AND COLOR IMAGE DISPLAY METHOD

(71) Applicant: SHARP KABUSHIKI KAISHA, Sakai City, Osaka (JP)

(72) Inventor: MASAMITSU KOBAYASHI, Sakai City (JP)

(21) Appl. No.: 15/772,087

(22) PCT Filed: Oct. 27, 2016
(86) PCT No.: PCT/JP2016/081827

§ 371 Date: Apr. 29, 2018

(30) Foreign Application Priority Data
Nov. 2, 2015 (JP) 2015-215905

(51) Int. Cl. G09G 3/36; G09G 3/20

(52) U.S. Cl. CPC G09G 3/3607; G09G 2320/0242; G09G 3/3648; G09G 3/2003

(57) ABSTRACT

The present invention provides a field-sequential color image display device inhibiting color breakup and a reduction of the range of color reproduction while achieving enhanced transparency of a transparent display area.

In the field-sequential liquid crystal display device, a light source data computation portion (206) obtains drive light source data Eₖ by modifying initial light source data on the basis of a transparent color, which is a target color TCₖ, and a target color display area proportion TPₖ, which is obtained from input data Dᵢₙ, such that transparency of a transparent display area in an image to be displayed increases. On the basis of the drive light source data Eₖ, a light source driver portion (210) drives red, green, and blue LEDs of a light source portion (120) for respective frame periods within a frame period during which the image represented by the input data is to be displayed. A spatial light modulation drive portion (214) controls transmittance through a liquid crystal panel in a pixel array portion (110), for each pixel so as to maximize transmittance through the transparent display area.

### TECHNICAL FIELD

The present invention relates to color image display devices, more specifically to a color image display device, such as a liquid crystal display device which is capable of displaying a color image by a field-sequential system while achieving display in a transparent display mode.

### BACKGROUND ART

Most liquid crystal display devices that display color images include color filters respectively transmitting red (R), green (G), and blue (B) light therethrough, the filters being provided for each set of three subpixels into which each pixel is divided. However, about ⅔ of the backlight that illuminates a liquid crystal panel is absorbed by the color filters, and therefore such a liquid crystal display device using color filters has low light-use efficiency. Accordingly, field-sequential liquid crystal display devices, which achieve display in colors without using color filters, are drawing attention.

In a typical field-sequential liquid crystal display device, one frame period, which is a display period for one screen, is divided into three subframe periods, namely, first, second, and third subframe periods. While the back of the liquid crystal panel is irradiated with red, green, and blue source light during the first, second, and third subframe periods, a red image in accordance with a red component of an input image signal is displayed during the first subframe period, a green image in accordance with a green component is displayed during the second subframe period, and a blue image in accordance with a blue component is displayed during the third subframe period, with the result that a color image is displayed on the liquid crystal panel (hereinafter, such a field-sequential system will be referred to as a “simple RGB subframe system” or a “first field-sequential system”). Such a field-sequential liquid crystal display device can dispense with color filters and therefore has high light-use efficiency when compared to liquid crystal display devices using color filters.

However, in the case of the field-sequential display device, when an observer's line of sight to a display screen changes, the observer might perceive time lags in lighting up between primary colors of light sources and see the colors of the subframes separately (such a phenomenon being referred to as “color breakup”). In a known method for inhibiting color breakup, at least one of the red, green, and blue components is displayed in two or more subframes per frame period. For example, in the case of a field-sequential display device in which one frame period includes white, red, green, and blue subframe periods for displaying white, red, green, and blue images, respectively, the red image, which is a red component of an image represented by an input image signal, is displayed during red and white field periods, the green image, which is a green component, is displayed during a green field period and the white field period, and the blue image, which is a blue component, is displayed during a blue field period and the white field period (hereinafter, such a field-sequential system will be referred to as an “RGB+W subframe system”, a “common color subframe system”, or a “second field-sequential system”).

Consider here the situation where white is displayed with maximum luminance on a field-sequential liquid crystal display panel. In the case of a display device in accordance with the simple RGB subframe system used in this situation, transmittance through corresponding pixels (optical modulation pixels) of the liquid crystal panel is maximized during any of the red, green, and blue subframe periods, so that the entire light from light sources is utilized for display. On the other hand, in the case of a liquid crystal display device in accordance with the common color subframe system (or the RGB+W subframe system), transmittance through the optical modulation pixels is maximized during the white subframe period, but during the red, green, and blue subframe periods, the optical modulation pixels transmit no light therethrough, even though the light sources emit light. Accordingly, in the case where the common color subframe system is employed for the field-sequential liquid crystal display device, light-use efficiency and maximum luminance are low when compared to the simple RGB subframe system.

In this regard, some approaches have been proposed for the purpose of inhibiting color breakup while enhancing light-use efficiency or maximum luminance. Specifically, the proposed approaches include configurations in which white is displayed during all subframe periods (see, for example, Japanese Patent Nos. 3215913 and 5386211) and a drive method in which an offset can be suitably applied to light sources (see, for example, Japanese Patent No. 4254317). However, these approaches involve either a decrease in the range of color reproduction due to reduced color saturation or both a reduction in the effect of inhibiting color breakup and deterioration of the quality of additive color mixing. For the sake of reference in the following descriptions, the field-sequential system in the configuration where white is displayed during all subframe periods, as described in, for example, Japanese Patent No. 5386211, will be referred to as the “third field-sequential system”.

In contrast, there are known approaches in which colors of light emitted by light sources are rendered variable during subframes or common color subframes in accordance with information included in an input image to the display device, by taking advantage of color representation being limited depending on the input image (hereinafter, this approach will be referred to as the “variable-color subframe system”). For example, in some of these known approaches, XBGR drive is performed using frame periods, each including an X-subframe period during which the color of a display image is variable (i.e., the color of light emitted by the light source is variable), in addition to R-, G-, and B-subframe periods during which red, green, and blue images are respectively displayed (see, for example, Japanese Patent No. 3952362 and International Publication WO 2012/099039). In these approaches, the color X of light emitted by the light source during the X-subframe period is determined on the basis of information included in the input image, regarding, for example, averages of the R-, G-, and B-luminance values among pixels in a target display area. Moreover, in another proposed approach, colors of light emitted by light sources are rendered variable during subframe periods and determined on the basis of the ratio of the color components, R, G, and B, among pixels (International Publication WO 2012/099039).

To realize inhibition of color breakup and enhancement of light-use efficiency, such a variable-color subframe system limits the range of color reproduction determined by the amount of light from each light source during each subframe period, by taking advantage of the range of color reproduction by the input image being limited. More specifically, the variable-color subframe system presupposes that the input image is displayed properly (i.e., the quality of additive color mixing is maintained). Therefore, it is not possible to achieve enhanced luminance, as achieved in the aforementioned approaches for inhibiting color breakup and enhancing light-use efficiency or maximum luminance.

Furthermore, other approaches have been proposed in conjunction with a type of the variable-color subframe system in which a drive mode in accordance with the field-sequential system, such as simple RGB drive, and a drive mode in which an image is displayed in limited colors are switched therebetween on the basis of an input image (e.g., Japanese Patent No. 3673317, Japanese Patent No. 4014363, and Japanese Laid-Open Patent Publication No. 2003-60944). However, to enhance luminance, these approaches presuppose that the image is displayed in one color (i.e., the light source emits light in one color) during each subframe period. Therefore, when an image is displayed in two or more colors, color breakup inhibition and luminance enhancement cannot be achieved properly.

Incidentally, using the field-sequential system eliminates the need for color filters for the liquid crystal panel, which results in enhanced transmission and thereby renders it possible to realize a transparent display. For such a transparent display based on the field-sequential system, there are two known types: housing-case and stand-alone types.

The housing-case-type transparent display includes a case in which an object can be housed, a light source for emitting light sequentially in R (red), G (green), and B (blue) within the case, and a liquid crystal panel for displaying an image in synchronization with the light-emission operation by the light source, the panel covering a portion of the case (see, for example, Japanese Patent No. 3526783 and FIG. 2 to be described later). In the case of the housing-case-type transparent display, the observer can see an image displayed on the liquid crystal panel while perceiving light from the back of the liquid crystal panel. However, when the liquid crystal panel of the housing-case-type transparent display is in a transmission mode, if background light, which is light from the back of the liquid crystal panel, is desirably perceived to be brighter, it is necessary to increase the light intensity of the light source illuminating the inside of the case. However, the light source illuminating the inside of the case emits light sequentially in a plurality of colors (R, G, and B) for displaying a color image. Therefore, if the light intensity of the light source illuminating the inside of the case is increased, intense color breakup is perceived in a display area of the liquid crystal panel that is rendered transparent (hereinafter, referred to as a “transparent display area”).

The stand-alone-type transparent display includes a display panel, which includes a light-scattering liquid crystal, etc., and a transparent backlight or a transparent front light (or light guide), which illuminates the display panel, and the stand-alone-type transparent display is configured so as to be switchable between a display mode for image display and a transparent mode in which light from the back can be perceived (see, for example, Japanese Laid-Open Patent Publication No. 2004-184981 and FIG. 3 to be described later). In the case of the stand-alone-type transparent display, the observer can see an image displayed on the display panel while perceiving light from the back. The stand-alone-type transparent display has difficulty in becoming completely transparent when the front light is lit up. Accordingly, to allow background light, which is light from the back of the display panel, to appear bright when the liquid crystal in the display panel is rendered in a transmission mode, it is necessary to weaken the brightness of the front light (i.e., the light guide) so as to be relatively low when compared to the background light. However, the source light from the front light is intended for displaying a color image on the display panel, and therefore, when the intensity of the source light decreases, the image is displayed darker.

### CITATION LIST

### Patent Documents

Patent Document 1: Japanese Patent No. 3215913

Patent Document 2: Japanese Patent No. 5386211

Patent Document 3: Japanese Patent No. 4254317

Patent Document 4: Japanese Patent No. 3952362

Patent Document 5: International Publication WO 2012/099039

Patent Document 6: Japanese Patent No. 3673317

Patent Document 7: Japanese Patent No. 4014363

Patent Document 8: Japanese Laid-Open Patent Publication No. 2003-60944

Patent Document 9: Japanese Patent No. 3526783

Patent Document 10: Japanese Laid-Open Patent Publication No. 2004-184981

### SUMMARY OF THE INVENTION

### Problems to be Solved by the Invention

In the case of the field-sequential display device, when the common color subframe is employed in order to inhibit color breakup caused by the field-sequential system, maximum luminance or light-use efficiency is reduced, as has been described above in conjunction with the conventional art. On the other hand, when offset settings are made for the light sources in order to enhance, for example, maximum luminance while inhibiting color breakup, problems such as a decrease in the range of color reproduction occur. Moreover, in the case of the variable-color subframe system in which the colors of light emitted by the light sources are rendered variable during subframes or common color subframes in accordance with information included in an input image, it is not possible to achieve significant effects in luminance enhancement and color breakup inhibition. On the other hand, in the case of the field-sequential transparent display, when an attempt is made to allow background light to appear brighter (i.e., to enhance luminance, namely, transparency, in the transparent display mode), the housing-case type incurs a problem where intense color breakup is perceived, whereas the stand-alone type incurs a problem where the image is displayed darker.

Therefore, an objective of the present invention is to provide a color image display device serving as a field-sequential transparent display which inhibits color breakup and a decrease of the range of color reproduction while enhancing the transparency of a transparent display area.

### Solutions to the Problem

A first aspect of the present invention provides a color image display device capable of displaying a color image by a field-sequential system with a plurality of subframe periods being included in each frame period, as well as capable of achieving display in a transparent color with a display portion on which to form an image to be displayed being rendered in a transparent state in units of pixels, the device including:

a light source portion configured to be able to emit light in different colors during the respective subframe periods on the basis of preset initial light source data;

a spatial light modulation portion configured to transmit light derived from the light source portion therethrough;

a light source data computation portion configured to generate drive light source data by modifying the initial light source data on the basis of input data representing an image to be displayed, so as to increase transparency of a transparent display area, wherein the drive light source data designates a color and an intensity of light emitted by the light source portion for each of the subframe periods, and the transparent display area corresponds to a portion of the image to be displayed, the portion being to be displayed in the transparent color; and

a modulation data computation portion configured to generate drive modulation data designating transmittance of the spatial light modulation portion for each pixel of the image to be displayed, on the basis of the input data.

A second aspect of the present invention provides the color image display device according to the first aspect of the present invention, further including an input data judgment portion configured to obtain a transparent display area proportion on the basis of the input data, the transparent display area proportion representing a proportion of the transparent display area in the image to be displayed, wherein,

the light source data computation portion generates the drive light source data by modifying the initial light source data in accordance with the transparent display area proportion so as to enhance the transparency of the transparent display area.

A third aspect of the present invention provides the color image display device according to the first aspect of the present invention, further including an input data judgment portion configured to obtain a target color display area proportion for each target color on the basis of the input data, the target color display area proportion representing a proportion of a target color display area to be displayed in the target color in the image to be displayed, the target color being determined for each of the subframe periods on the basis of the initial light source data such that the target color for a subframe period corresponding to a color whose saturation is minimum or maximum among all colors of light respectively designated by the initial light source data for the subframe periods, is a transparent color and the target colors for the other subframe periods are colors of light respectively designated by the initial light source data for those other subframe periods, wherein,

the light source data computation portion generates the drive light source data by modifying the initial light source data such that the light emitted by the light source portion during each of the subframe periods approximates the light in the target color in accordance with the target color display area proportion.

A fourth aspect of the present invention provides the color image display device according to the third aspect of the present invention, wherein,

each frame period includes four subframe periods consisting of first through fourth subframe periods,

the light source portion includes a first, second, and third light sources respectively emitting light in three primary colors consisting of first, second, and third primary colors, and

the initial light source data is light source data for causing the first, second, and third light sources to emit light during the first subframe period, causing only the first light source to emit light during the second subframe period, causing only the second light source to emit light during the third subframe period, and causing only the third light source to emit light during the fourth subframe period.

A fifth aspect of the present invention provides the color image display device according to the fourth aspect of the present invention, wherein,

the display portion is configured such that the transparency of the transparent display area increases with an emission intensity of the light source portion, and

the light source data computation portion generates the drive light source data by modifying the initial light source data such that emission intensities of the first, second, and third light sources during the first subframe period increase in accordance with the transparent display area proportion.

A sixth aspect of the present invention provides the color image display device according to the fourth aspect of the present invention, wherein,

the display portion is configured such that the transparency of the transparent display area increases as an emission intensity of the light source portion decreases, and

the light source data computation portion generates the drive light source data by modifying the initial light source data such that emission intensities of the first, second, and third light sources during the first subframe period decrease in accordance with the transparent display area proportion.

A seventh aspect of the present invention provides the color image display device according to any one of the first through third aspects of the present invention, further including an input data judgment portion configured to obtain a transparent display area proportion on the basis of the input data, the transparent display area proportion representing a proportion of the transparent display area in the image to be displayed, wherein,

the display portion is configured such that the transparency of the transparent display area increases with an emission intensity of the light source portion,

the light source portion includes a plurality of light sources respectively emitting light in different colors, and

the light source data computation portion generates the drive light source data by modifying the initial light source data in accordance with the transparent display area proportion such that an average intensity of light emitted by each of the light sources to form the image to be displayed, taken from among the subframe periods, becomes higher than an average emission intensity of the light source among the subframe periods, the average emission intensity being indicated by the initial light source data.

A eighth aspect of the present invention provides the color image display device according to the seventh aspect of the present invention, wherein,

each frame period consists of at least three subframe periods, including first, second, and third subframe periods,

the light source portion includes first, second, and third light sources respectively emitting light in different colors,

the initial light source data is light source data for causing only the first light source to emit light during the first subframe period, causing only the second light source to emit light during the second subframe period, and causing only the third light source to emit light during the third subframe period, and

the light source data computation portion generates the drive light source data by modifying the initial light source data in accordance with the transparent display area proportion such that the second and third light sources, along with the first light source, emit light during the first subframe period, the first and third light sources, along with the second light source, emit light during the second subframe period, and the first and second light sources, along with the third light source, emit light during the third subframe period.

A ninth aspect of the present invention provides the color image display device according to any one of the first through third aspects of the present invention, further comprising an input data judgment portion configured to obtain a transparent display area proportion on the basis of the input data, the transparent display area proportion representing a proportion of the transparent display area in the image to be displayed, wherein,

the display portion is configured such that the transparency of the transparent display area increases as an emission intensity of the light source portion decreases,

the light source portion includes a plurality of light sources respectively emitting light in different colors, and

the light source data computation portion generates the drive light source data in accordance with the transparent display area proportion such that an average intensity of light emitted by each of the light sources to form the image to be displayed, taken from among the subframe periods, becomes lower than an average emission intensity of the light source among the subframe periods, the average emission intensity being indicated by the initial light source data.

A tenth aspect of the present invention provides the color image display device according to the ninth aspect of the present invention, wherein,

each frame period consists of at least three subframe periods, including first, second, and third subframe periods,

the light source portion includes first, second, and third light sources respectively emitting light in different colors,

the initial light source data is light source data for causing only the first light source to emit light during the first subframe period, causing only the second light source to emit light during the second subframe period, and causing only the third light source to emit light during the third subframe period, and

the light source data computation portion generates the drive light source data by modifying the initial light source data in accordance with the transparent display area proportion such that the first light source has a decreased emission intensity during the first subframe period, the second light source has a decreased emission intensity during the second subframe period, and the third light source has a decreased emission intensity during the third subframe period.

A eleventh aspect of the present invention provides a color image display method for a display device capable of displaying a color image by a field-sequential system with a plurality of subframe periods being included in each frame period, as well as capable of achieving display in a transparent color with a display portion on which to form an image to be displayed being rendered in a transparent state in units of pixels, the method including:

a light source emission step of emitting light for forming the image to be displayed, from a light source portion configured to be able to emit light in different colors during the respective subframe periods on the basis of preset initial light source data;

a spatial light modulation step of changing transmittance through a spatial light modulation portion configured to transmit light derived from the light source portion therethrough, on the basis of input data representing an image to be displayed;

a light source data computation step of generating drive light source data by modifying the initial light source data on the basis of the input data so as to increase transparency of a transparent display area, wherein the drive light source data designates a color and an intensity of light emitted by the light source portion for each of the subframe periods, and the transparent display area corresponds to a portion of the image to be displayed, the portion being to be displayed in the transparent color; and

a modulation data computation step of generating drive modulation data on the basis of the input data, the drive modulation data designating the transmittance of the spatial light modulation portion for each pixel of the image to be displayed.

Other aspects of the present invention are clear from the above description of the first through the eleventh aspects of the present invention and from description of each embodiment to be made herein later, and therefore any descriptions thereof will be omitted herein.

### Effect of the Invention

According to the first aspect of the present invention, the drive light source data, which designates the color and the intensity of light emitted by the light source portion during each of the subframe periods in each frame period, is generated by modifying the initial light source data on the basis of the input data representing the image to be displayed, such that the transparency of the transparent display area in the image to be displayed increases. Thus, it is possible to inhibit color breakup and a reduction in display color saturation while enhancing the transparency of the transparent display area.

According to the second aspect of the present invention, the transparent display area proportion, which represents a proportion of the transparent display area in the image to be displayed, is obtained on the basis of the input data, and the drive light source data is generated by modifying the initial light source data in accordance with the transparent display area proportion such that the transparency of the transparent display area increases. Thus, it is possible to inhibit color breakup and a reduction in display color saturation while enhancing the transparency of the transparent display area in accordance with the transparent display area proportion.

According to the third aspect of the present invention, the target color display area proportion is obtained on the basis of the input data, for each of the target colors determined for their respective subframe periods in each frame period, such that the target color for a subframe period corresponding to a color whose saturation is minimum or maximum among all colors of light respectively designated by the initial light source data for the subframe periods, is a transparent color and the target colors for the other subframe periods are colors of light respectively designated by the initial light source data for those other subframe periods. Then, the drive light source data is generated by modifying the initial light source data such that the light emitted by the light source portion during each subframe period approximates to the light in the target color in accordance with the target color display area proportion. Thus, it is possible to inhibit color breakup and a reduction in chromatic color saturation in a display image while enhancing the transparency of the transparent display area.

According to the fourth aspect of the present invention, the first, second, and third light sources, which respectively emit light in the three primary colors consisting of the first, second, and third primary colors, are used, and the light source data that is used as the initial light source data causes the first, second, and third light sources to emit light during the first subframe period, causes only the first light source to emit light during the second subframe period, causes only the second light source to emit light during the third subframe period, and causes only the third light source to emit light during the fourth subframe period, whereby effects similar to those achieved by the third aspect of the present invention can be achieved.

According to the fifth aspect of the present invention, the drive light source data is generated by modifying the initial light source data such that the emission intensities of the first, second, and third light sources during the first subframe period increase in accordance with the transparent display area proportion based on the input data. As a result, the average intensity of the light emitted by each light source to form the image to be displayed, taken from among a plurality of subframe periods corresponding to one frame period, becomes higher than the average emission intensity of the light source among the subframe periods, which is indicated by the initial light source data. Thus, in the case of a field-sequential color image display device with a display portion configured such that the transparency of the transparent display area increases with the emission intensity of the light source portion, as in the case of a housing-case-type transparent display, it is possible to achieve effects similar to those achieved by the fourth aspect of the present invention.

According to the sixth aspect of the present invention, the drive light source data is generated by modifying the initial light source data such that the emission intensities of the first, second, and third light sources during the first subframe period decrease in accordance with the transparent display area proportion based on the input data. As a result, the average intensity of the light emitted by each light source to form the image to be displayed, taken from among a plurality of subframe periods corresponding to one frame period, becomes lower than the average emission intensity of the light source among the subframe periods, which is indicated by the initial light source data. Thus, in the case of a field-sequential color image display device with a display portion configured such that the transparency of the transparent display area increases as the emission intensity of the light source portion decreases, as in the case of a stand-alone-type transparent display, it is possible to achieve effects similar to those achieved by the fourth aspect of the present invention.

According to the seventh aspect of the present invention, the drive light source data is generated by modifying the initial light source data in accordance with the transparent display area proportion based on the input data such that the average intensity of the light emitted by each light source to form the image to be displayed, taken from among a plurality of subframe periods corresponding to one frame period, becomes higher than the average emission intensity of the light source among the subframe periods, which is indicated by the initial light source data. Thus, in the case of a field-sequential color image display device with a display portion configured such that the transparency of the transparent display area increases with the emission intensity of the light source portion, as in the case of a housing-case-type transparent display, it is possible to achieve effects similar to those achieved by the first through third aspects of the present invention.

According to the eighth aspect of the present invention, each frame period consists of at least three subframe periods, including the first, second, and third subframe periods, the first, second, and third light sources, which respectively emit light in different colors, are used, and the light source data that is used as the initial light source data causes only the first light source to emit light during the first subframe period, causes only the second light source to emit light during the second subframe period, and causes only the third light source to emit light during the third subframe period; in such a configuration, the drive light source data is generated by modifying the initial light source data in accordance with the transparent display area proportion based on the input data such that the second and third light sources, along with the first light source, emit light during the first subframe period, the first and third light sources, along with the second light source, emit light during the second subframe period, and the first and second light sources, along with the third light source, emit light during the third subframe period. As a result, the average intensity of the light emitted by each light source to form the image to be displayed, taken from among a plurality of subframe periods corresponding to one frame period, becomes higher than the average emission intensity of the light source among the subframe periods, which is indicated by the initial light source data. Thus, in the case of a field-sequential color image display device with a display portion configured such that the transparency of the transparent display area increases with the emission intensity of the light source portion, as in the case of a housing-case-type transparent display, it is possible to achieve effects similar to those achieved by the first through third aspects of the present invention.

According to the ninth aspect of the present invention, the drive light source data is generated by modifying the initial light source data in accordance with the transparent display area proportion based on the input data such that the average intensity of the light emitted by each light source to form the image to be displayed, taken from among a plurality of subframe periods corresponding to one frame period, becomes lower than the average emission intensity of the light source among the subframe periods, which is indicated by the initial light source data. Thus, in the case of a field-sequential color image display device with a display portion configured such that the transparency of the transparent display area increases as the emission intensity of the light source portion decreases, as in the case of a stand-alone-type transparent display, it is possible to achieve effects similar to those achieved by the first through third aspects of the present invention.

According to the tenth aspect of the present invention, each frame period consists of at least three subframe periods, including the first, second, and third subframe periods, the first, second, and third light sources, which respectively emit light in different colors, are used, and the light source data that is used as the initial light source data causes only the first light source to emit light during the first subframe period, causes only the second light source to emit light during the second subframe period, and causes only the third light source to emit light during the third subframe period; in such a configuration, the drive light source data is generated by modifying the initial light source data in accordance with the transparent display area proportion based on the input data such that the first light source has a decreased emission intensity during the first subframe period, the second light source has a decreased emission intensity during the second subframe period, and the third light source has a decreased emission intensity during the third subframe period. As a result, the average intensity of the light emitted by each light source to form the image to be displayed, taken from among a plurality of subframe periods corresponding to one frame period, becomes lower than the average emission intensity of the light source among the subframe periods, which is indicated by the initial light source data. Thus, in the case of a field-sequential color image display device with a display portion configured such that the transparency of the transparent display area increases as the emission intensity of the light source portion decreases, as in the case of a stand-alone type transparent display, it is possible to achieve effects similar to those achieved by the first through third aspects of the present invention.

Effects of other aspects of the present invention are apparent from the effects of the first through tenth aspect of the invention and also from the description of the following embodiments of the present invention, and therefore any descriptions thereof will be omitted herein.

### BRIEF DESCRIPTION OF THE DRAWINGS

FIG. 1 is a schematic block diagram illustrating a general configuration of a liquid crystal display device according to a first embodiment of the present invention.

FIG. 2 is a perspective view illustrating a housing-case-type transparent display as a first example of the liquid crystal display device according to the first embodiment.

FIG. 3 is a perspective view for describing the configuration of an essential part of a stand-alone-type transparent display with full-surface light emission, illustrated as a second example of the liquid crystal display device according to the first embodiment.

FIG. 4 is a cross-sectional view for describing the configuration of the essential part of the stand-alone-type transparent display device illustrated as the second example.

FIG. 5 is a perspective view for describing the configuration of an essential part of a stand-alone-type transparent display device with local light emission, illustrated as a third example of the liquid crystal display device according to the first embodiment.

FIG. 6 is a cross-sectional view for describing the configuration of the essential part of the stand-alone-type transparent display device with local light emission, illustrated as the third example in the first embodiment.

FIG. 7 is a block diagram illustrating a functional configuration of the liquid crystal display device according to the first embodiment.

FIG. 8 is a timing chart for describing the operation of the liquid crystal display device according to the first embodiment where one frame period consists of three subframe periods (i.e., in the case of a three-subframe-configuration FS system).

FIG. 9 is a timing chart for describing the operation of the liquid crystal display device according to the first embodiment where one frame period consists of four subframe periods (i.e., in the case of a four-subframe-configuration FS system).

FIG. 10 is a flowchart showing an example of a light source data computation processing in the first embodiment.

FIG. 11 provides conceptual diagrams (A to C) for describing the range of color reproduction in HSV color space where the housing-case-type transparent display device, illustrated as the first example of the liquid crystal display device according to the first embodiment, employs any of first through third field-sequential systems.

FIG. 12 provides conceptual diagrams (A to C) for describing the range of color reproduction in HSV color space where the stand-alone-type transparent display device, illustrated as the second example of the liquid crystal display device according to the second embodiment, employs any of the first through third field-sequential systems.

FIG. 13 is a diagram illustrating an example of a display image for describing effects of the first embodiment.

FIG. 14 provides diagrams (A and B) for describing a first operation example in the first embodiment.

FIG. 15 provides diagrams (A and B) for describing a second operation example in the first embodiment.

FIG. 16 provides diagrams (A and B) for describing a third operation example in the first embodiment.

FIG. 17 provides diagrams (A and B) for describing a fourth operation example in the first embodiment.

FIG. 18 provides diagrams (A and B) for describing a fifth operation example in the first embodiment.

FIG. 19 provides diagrams (A and B) for describing a sixth operation example in the first embodiment.

FIG. 20 provides diagrams (A and B) for describing a first operation example in a second embodiment of the present invention.

FIG. 21 provides diagrams (A and B) for describing a second operation example in the second embodiment.

FIG. 22 provides diagrams (A and B) for describing an operation example in a variant of the second embodiment.

### MODES FOR CARRYING OUT THE INVENTION

Hereinafter, embodiments of the present invention will be described. In the following, one frame period is a time period for refreshing one screen (i.e., rewriting a display image), and the “one frame period” is assumed to last for the duration of one frame period (16.67 ms) for a typical display device whose refresh rate is 60 Hz, but this is not intended to limit the present invention.

### 1. First Embodiment

<1.1 General Configuration>

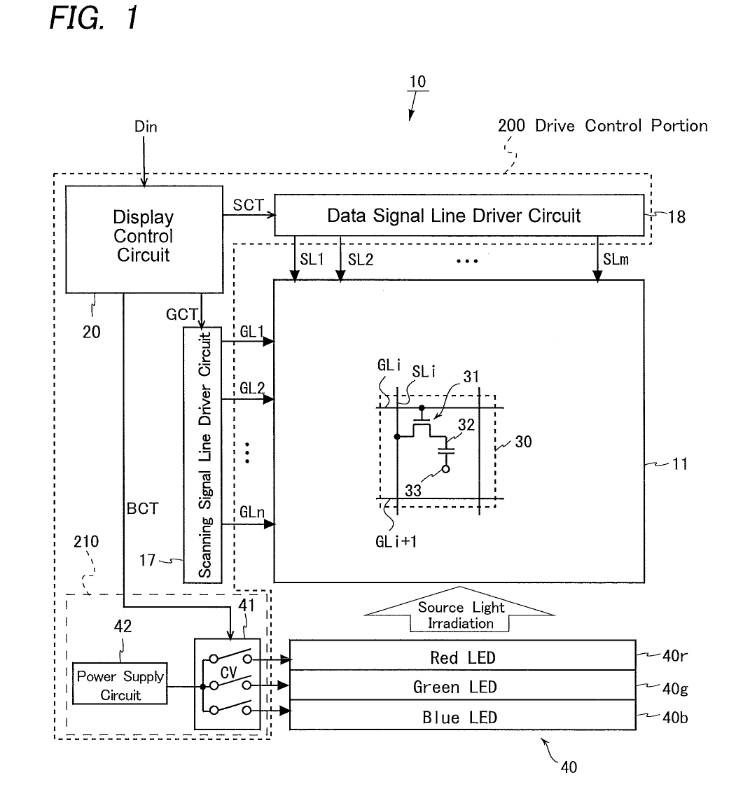

FIG. 1 is a schematic block diagram illustrating a general configuration of a field-sequential liquid crystal display device according to a first embodiment of the present invention. The liquid crystal display device 10 displays a color image by a field-sequential system in which one frame period is divided into three or four subframe periods (also referred to as “field periods”). The liquid crystal display device 10 includes a liquid crystal panel 11, which serves as a display panel, a display control circuit 20, a scanning signal line driver circuit 17, a data signal line driver circuit 18, a light source unit 40, and a light source driver portion 210 including a switch group 41 and a power supply circuit 42. Note that the display control circuit 20, the scanning signal line driver circuit 17, the data signal line driver circuit 18, and the light source driver portion 210 (i.e., the switch group 41 and the power supply circuit 222) constitute a drive control portion 200. Moreover, the liquid crystal panel 11 functions as a spatial light modulation portion (to be described in detail later) driven by the scanning signal line driver circuit 17 and the data signal line driver circuit 18 to control transmittance of light illuminating the back thereof, on a pixel by pixel basis.

The liquid crystal panel 11 includes a plurality of (m) data signal lines SL₁ to SLₘ, a plurality of (n) scanning signal lines GL₁ to GLₙ, and a plurality of (m×n) pixel forming portions 30 provided corresponding to respective intersections of the data signal lines SL₁ to SLₘ and the scanning signal lines GL₁ to GLₙ. Each pixel forming portion 30 includes a TFT 31 which serves as a switching element, a pixel electrode 32 which is connected to a drain terminal of the TFT 31, and a common electrode 33 which forms a liquid crystal capacitor along with the pixel electrode 32. The TFT 31 has a gate terminal connected to the scanning signal line GLᵢ(where 1≤i≤n) and a source terminal connected to the data signal line SLⱼ (where 1≤j≤m).

The display control circuit 20 externally receives an input signal Dᵢₙ. The input signal Dᵢₙ includes an input image signal which includes red, green, and blue image signals Rᵢₙ, Gᵢₙ, and Bᵢₙ representing red, green, and blue components, respectively, of an image to be displayed, and the input signal Dᵢₙ also includes a control signal which specifies, for example, timing required for displaying the image represented by the input image signal. On the basis of such an input signal Dᵢₙ, the display control circuit 20 generates a scanning control signal GCT, a data control signal SCT, and a light source control signal BCT. The scanning control signal GCT, the data control signal SCT, and the light source control signal BCT are respectively provided to the scanning signal line driver circuit 17, the data signal line driver circuit 18, and (the switch group 41 of) the light source driver portion 210.

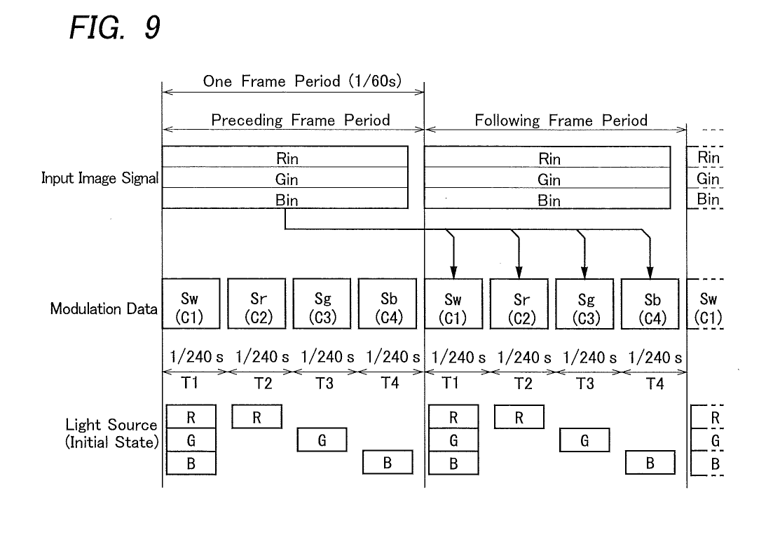

The scanning control signal GCT provided to the scanning signal line driver circuit 17 includes, for example, a scanning start pulse signal and a scanning clock signal. In accordance with these signals, the scanning signal line driver circuit 17 applies an active scanning signal sequentially to the scanning signal lines GL₁ to GLₙ. As will be described later, in the present embodiment, in the case of a field-sequential system in which each frame period consists of three subframe periods (hereinafter, referred to as a “three-subframe-configuration FS system”), the frame period is divided into the following three subframe periods (see FIG. 8 to be described later): a first subframe period (also referred to as an “R-subframe period”) T₁ during which a red image represented by the inputted red image signal Rᵢₙ is displayed; a second subframe period (also referred to as a “G-subframe period”) T₂ during which a green image represented by the inputted green image signal Gᵢₙ is displayed; and a third subframe period (also referred to as a “B-subframe period”) T₃ during which a blue image represented by the inputted blue image signal Bᵢₙ is displayed. Moreover, in the case of a field-sequential system in which each frame period consists of four subframe periods (hereinafter, referred to as a “four-subframe-configuration FS system”), a white gradation signal Wf, a red gradation signal Rf, a green gradation signal Gf, and a blue gradation signal Bf, which are signals to indicate display intensities, are generated on the basis of the inputted red, green, and blue image signals Rᵢₙ, Gᵢₙ, and Bᵢₙ, and the frame period is divided into the following four subframe periods (see FIG. 9 to be described later): a first subframe period (also referred to as a “W-subframe period”) T₁ during which a white image represented by the white gradation signal Wf is displayed; a second subframe period (also referred to as an “R-subframe period”) T₂ during which a red image represented by the red gradation signal Rf is displayed; a third subframe period (also referred to as a “G-subframe period”) T₃ during which a green image represented by the green gradation signal Gf is displayed; and a fourth subframe period (also referred to as a “B-subframe period”) T₄ during which a blue image represented by the blue gradation signal Bf is displayed. The scanning signal line driver circuit 17 applies an active scanning signal sequentially to the n scanning signal lines GL₁ to GLₙ during each of the first to third subframe periods T₁ to T₃ in the case of the three-subframe-configuration FS system or during each of the first to fourth subframe periods T₁ to T₄ in the case of the four-subframe-configuration FS system.

The data control signal SCT provided to the data signal line driver circuit 18 includes modulation data for controlling light transmittance through each pixel forming portion 30 for use in forming an image to be displayed, in addition to a data start pulse signal, a data clock signal, a latch strobe signal, etc. In accordance with these signals, the data signal line driver circuit 18 operates unillustrated internal components thereof, including a shift register, a sampling latch circuit, etc., with the result that parallel digital signals corresponding to the modulation data are sequentially converted to analog signals for respective subframe periods by an unillustrated D/A conversion circuit, thereby generating m data signals as drive image signals, which are respectively applied to the data signal lines SL₁ to SLₘ.

Here, in the case of the three-subframe-configuration FS system, three types of parallel digital signals respectively corresponding to red, green, and blue modulation signals Sᵣ, S_{g}, and S_{b}, which are modulation data, are sequentially converted to analog signals for respective subframe periods by the unillustrated D/A conversion circuit, thereby generating m data signals as drive image signals, with the result that the data signals that represent a red image based on the red modulation signal Sᵣ are applied to the data signal lines SL₁ to SLₘ during the first subframe period T₁, the data signals that represent a green image based on the green modulation signal S_{g} are applied during the second subframe period T₂, and the data signals that represent a blue image based on the blue modulation signal S_{b} are applied during the third subframe period T₃.

On the other hand, in the case of the four-subframe-configuration FS system, four types of parallel digital signals respectively corresponding to white, red, green, and blue modulation signals S_{w}, Sᵣ, S_{g}, and S_{b}, which are modulation data, are sequentially converted to analog signals for respective subframe periods by an unillustrated D/A conversion circuit, thereby generating m data signals as drive image signals, with the result that the data signals that represent a white image based on the white modulation signal S_{w} are applied to the data signal lines SL₁ to SLₘ during the first subframe period T₁, the data signals that represent a red image based on the red modulation signal Sᵣ are applied during the second subframe period T₂, the data signals that represent a green image based on the green modulation signal S_{g} are applied during the third subframe period T₃, and the data signals that represent a blue image based on the blue modulation signal S_{b} are applied during the fourth subframe period T₄.

It should be noted that as will be described later, the red, green, and blue modulation signals Sᵣ, S_{g}, and S_{b}, which serve as modulation data in the three-subframe-configuration FS system, respectively correspond to the inputted red, green, and blue image signals Rᵢₙ, Gᵢₙ, and Bᵢₙ, and the white, red, green, and blue modulation signals S_{w}, Sᵣ, S_{g}, and S_{b}, which serve as modulation data in the four-subframe-configuration FS system, respectively correspond to the white, blue, green, and red gradation signals Wf, Bf, Gf, and Rf, which indicate display intensities.

The light source unit 40 is composed of red, green, and blue LEDs (light-emitting diodes) 40ᵣ, 40_{g}, and 40_{b}, which serve as red, green, and blue light sources, respectively, and there are several examples of the light source unit, such as direct, edge-light, and projection types. In the case of the direct type, the light source unit 40 is composed of the red, green, and blue LEDs 40ᵣ, 40_{g}, and 40_{b} arranged two-dimensionally on the back side of the liquid crystal panel 11. In the case of the edge-light type, the light source unit 40 is composed of the red, green, and blue LEDs 40ᵣ, 40_{g}, and 40_{b} arranged one-dimensionally along a side of the liquid crystal panel 11. In the case of the projection type, the light source unit 40 is composed of the red, green, and blue LEDs 40ᵣ, 40_{g}, and 40_{b} positioned so as to be out of the observer's field of view and project emission light onto the back of the liquid crystal panel 11.

The red, green, and blue LEDs 40ᵣ, 40_{g}, and 40_{b} are configured to be connectable independently on a color by color basis to the power supply circuit 42 via the switch group 41. In the case of the three-subframe-configuration FS system, the display control circuit 20 provides the light source control signal BCT to the switch group 41, whereby in the initial state (at the time of power-on), as shown in FIG. 8, the light source unit 40 lights up only the red LEDs 40ᵣ during the red subframe period (i.e., the first subframe period) T₁, only the green LEDs 40_{g} during the green subframe period (i.e., the second subframe period) T₂, and only the blue LEDs 40_{b} during the blue subframe period (i.e., the third subframe period) T₃. In the case of the four-subframe-configuration FS system, the display control circuit 20 provides the light source control signal BCT to the switch group 41, whereby in the initial state, as shown in FIG. 9, the light source unit 40 lights up all of the red, green, and blue LEDs 40ᵣ, 40_{g}, and 40_{b} during the white subframe period (i.e., the first subframe period) T₁, only the red LEDs 40ᵣ during the red subframe period (i.e., the second subframe period) T₂, only the green LEDs 40_{g} during the green subframe period (i.e., the third subframe period) T₃, and only the blue LEDs 40_{b} during the blue subframe period (i.e., the fourth subframe period) T₄. Here, the drive control portion 200 is configured to be able to adjust the emission intensities of the LEDs 40ᵣ, 40_{g}, and 40_{b}, for example, through pulse-width modulation by the switch group 41. In the present embodiment, the light sources that are lit up during the subframe periods and emission intensities thereof vary in accordance with the input image signal included in the input signal Dᵢₙ, except in the initial state; details will be described later. Note that in the case of the four-subframe-configuration FS system, the present embodiment is configured such that the three types of light sources, i.e., the red, green, and blue LEDs 40ᵣ, 40_{g}, and 40_{b}, can irradiate (the back of) the liquid crystal panel 11 with the four types of source light, i.e., the red, green, blue, and white light, but this configuration is not limiting. For example, white LEDs for emitting white light may be provided in addition to the red, green, and blue LEDs 40ᵣ, 40_{g}, and 40_{b}, such that the white LEDs, either alone or in combination with the red, green, and blue LEDs 40ᵣ, 40_{g}, and 40_{b}, emit light during the white subframe period T₁. Note that the light sources that emit white light will be referred to below as the “white light sources” regardless of whether the light sources include the red, green, and blue LEDs 40ᵣ, 40_{g}, and 40_{b} or include only the white LEDs.

As described above, in the present embodiment, the data signals are applied to the data signal lines SL₁ to SLₘ, and the active scanning signal is applied sequentially to the scanning signal lines GL₁ to GLₙ, with the result that in the initial state, the light source unit 40 irradiates the back of the liquid crystal panel 11 with, in the case of the three-subframe-configuration FS system, red, green, and blue light sequentially for one subframe period each or, in the case of the four-subframe-configuration FS system, white, red, green, and blue light sequentially for one subframe period each. Moreover, when the common electrode 33, which is provided in common for the pixel forming portions 30 of the liquid crystal panel 11, is supplied with a predetermined voltage from an unillustrated common electrode driver circuit, the pixel electrodes 32 and the common electrode 33 apply voltages corresponding to the red, green, and blue modulation signal Sᵣ, S_{g}, and S_{b} or the white, red, green, and blue modulation signal S_{w}, Sᵣ, S_{g}, and S_{b} to the liquid crystal in the pixel forming portions 30. In this manner, a color image represented by an input image signal is displayed on the liquid crystal panel 11 by virtue of temporal additive color mixing, which, in the case of the three-subframe-configuration FS system, results from transmittance of the red, green, and blue light, which irradiate the back of the liquid crystal panel 11 during the red, green, and blue subframe periods T₁, T₂, and T₃, respectively, being controlled by the voltages applied to the liquid crystal in the pixel forming portions 30, or, in the case of the four-subframe-configuration FS system, results from the transmission of the white, red, green, and blue light, which irradiate the back of the liquid crystal panel 11 during the white, red, green, and blue subframe periods T₁, T₂, T₃, and T₄, respectively, being controlled by the voltages applied to the liquid crystal in the pixel forming portions 30.

It should be noted that as will be described later, the three-subframe-configuration FS system and the four-subframe-configuration FS system are the same as conventional field-sequential systems in that a color image is displayed by virtue of temporal additive color mixing (details will be described later), except that, in the case of the three-subframe-configuration FS system, the red, green, or blue light is not the only light that irradiates the liquid crystal panel 11 during the first, second, or third subframe period T₁, T₂, or T₃, respectively, in states other than the initial state, and in the case of the four-subframe-configuration FS system, the white, red, green, or blue light is not the only light that irradiates the liquid crystal panel 11 during the first, second, third, or fourth subframe period T₁, T₂, T₃, or T₄, respectively, in states other than the initial state.

<1.2 Configuration and General Operation of the Essential Part>

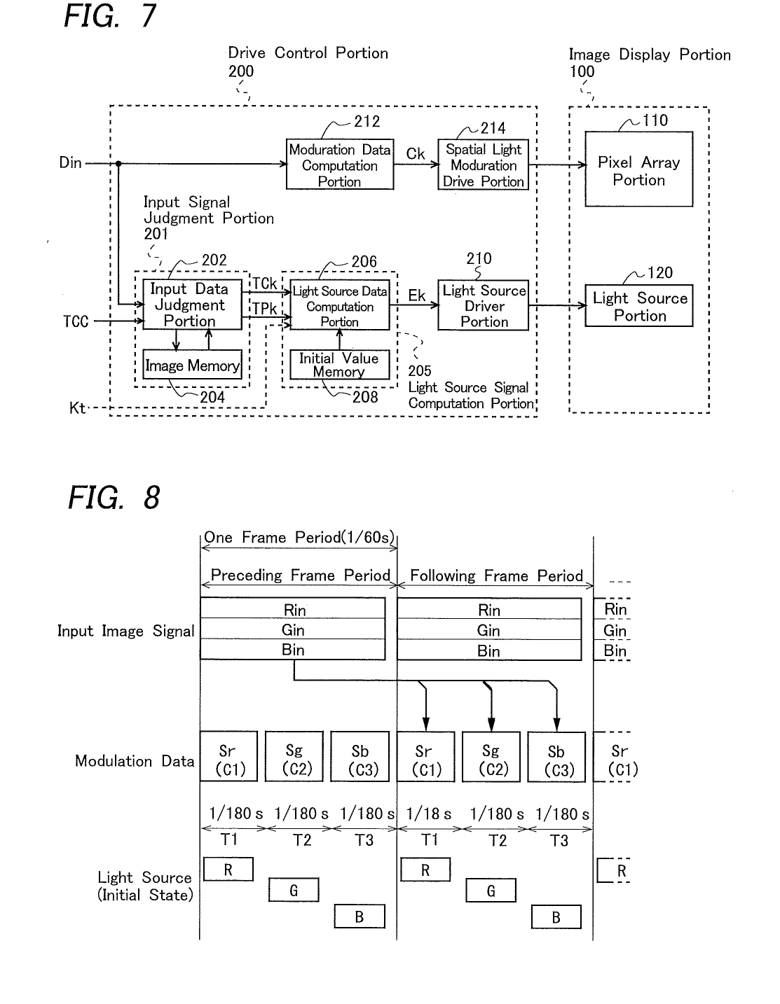

FIG. 7 is a block diagram illustrating a functional configuration of the liquid crystal display device 10 according to the present embodiment. FIG. 8 is a timing chart for describing the operation of the liquid crystal display device according to the present embodiment where the three-subframe-configuration FS system is employed. FIG. 9 is a timing chart for describing the operation of the liquid crystal display device according to the present embodiment where the four-subframe-configuration FS system is employed. The configuration and the general operation of an essential part of the present embodiment will be described below with reference to FIGS. 7 to 9. Note that in the following, any descriptions of the data start pulse signal and the data clock signal included in the data control signal SCT will be omitted, along with any descriptions of timing control signals such as the scanning control signal GCT.

Referring to FIGS. 7 and 8, described first are generation of modulation data Cₖ and light source data Eₖ and operations based on the data Cₖ and Eₖ where the three-subframe-configuration FS system is employed in the present embodiment. The modulation data Cₖ is a signal included in the data control signal SCT for driving the liquid crystal panel 11, and in the case of the three-subframe-configuration FS system, the modulation data Cₖ consists of first, second, and third modulation data C₁, C₂, and C₃ for controlling light transmittance through the pixel forming portions 30 during the first, second, and third subframe periods T₁, T₂, and T₃, respectively. In the present embodiment, the first to third modulation data C₁ to C₃ correspond to the aforementioned red, green, and blue modulation signals Sᵣ, S_{g}, and S_{b}, respectively.

The liquid crystal display device 10 according to the present embodiment functionally consists of an image display portion 100 and the drive control portion 200, as shown in FIG. 7. The image display portion 100 includes a pixel array portion 110, which corresponds to the liquid crystal panel 11, and a light source portion 120, which corresponds to the light source unit 40. The drive control portion 200 includes an input signal judgment portion 201, which consists of an input data judgment portion 202 and image memory 204, a light source signal computation portion 205, which consists of a light source data computation portion 206 and initial value memory 208, the light source driver portion 210, a modulation data computation portion 212, and a spatial light modulation drive portion 214, and an input signal Dᵢₙ is externally provided to the input data judgment portion 202 and the modulation data computation portion 212. Note that the input data judgment portion 202, the image memory 204, the light source data computation portion 206, the initial value memory 208, and the modulation data computation portion 212 are included in the display control circuit 20 shown in FIG. 1. In the initial state, the initial value memory 208 has stored therein initial light source data, which indicates the colors and the light emission intensities of light sources that emit light during respective subframe periods Tₖ, and the initial light source data includes light source data initial values Ebₖ (where k=1 to 3), which indicate initial values of emission intensities respectively for the red, green, and blue light sources 40ᵣ, 40_{g}, and 40_{b} during the subframe periods Tₖ. Moreover, the spatial light modulation drive portion 214 consists of the data signal line driver circuit 18 and the scanning signal line driver circuit 17.

In the case of the three-subframe-configuration FS system, each frame period is divided into three subframe periods, i.e., the first to third subframe periods T₁ to T₃, as shown in FIG. 8. Here, for the sake of description, focusing on two consecutive frame periods, the earlier of the two frame periods will be referred to as the “preceding frame period”, and the later one will be referred to as the “following frame period”.

The red, green, and blue image signals Rᵢₙ, Gᵢₙ, and Bᵢₙ, which are the input image signals in the input signal Dᵢₙ externally received during the preceding frame period are initially provided to the modulation data computation portion 212 and temporarily memorized in internal memory thereof. In accordance with predetermined computation based on the memorized red, green, and blue image signals Rᵢₙ, Gᵢₙ, and Bᵢₙ, the modulation data computation portion 212 generates first to third modulation data C₁ to C₃ to be outputted during the first to third subframe periods, respectively, in the following frame period. In the case where the three-subframe-configuration FS system is employed in the present embodiment, the modulation data computation portion 212 sequentially outputs the red, green, and blue image signals Rᵢₙ, Gᵢₙ, and Bᵢₙ respectively as a red modulation signal Sᵣ, which corresponds to the first modulation data C₁, during the first subframe period T₁, a green modulation signal S_{g}, which corresponds to the second modulation data C₂, during the second subframe period T₂, and a blue modulation signal S_{b}, which corresponds to the third modulation data C₃, during the third subframe period T₃.

The first to third modulation data C₁ to C₃ thus outputted by the modulation data computation portion 212 are provided to the spatial light modulation drive portion 214, such that the first modulation data C₁ (i.e., the red modulation signal Sᵣ) serves as a signal indicating transmittance through each pixel forming portion during the first subframe period T₁, the second modulation data C₂ (i.e., the green modulation signal S_{g}) as a signal indicating transmittance through each pixel forming portion during the second subframe period T₂, and the third modulation data C₃ (i.e., the blue modulation signal S_{b}) as a signal indicating transmittance through each pixel forming portion during the third subframe period T₃. The spatial light modulation drive portion 214 drives the pixel array portion 110 in accordance with the modulation data C₁ to C₃ during the following frame period.

On the other hand, the input data judgment portion 202 determines a target color TCₖ (where k=1, 2, 3) for each subframe period T_{K} in the following frame period in accordance with the externally received input signal Dᵢₙ. As a precondition of the determination of the target color TCₖ, one or more colors whose luminances are desired to be increased are designated as candidates for the target color. The target color candidates may be fixed in advance, but it is preferable that the candidates can be designated by a predetermined user operation or specified by information contained in the input signal Dᵢₙ. However, in the present embodiment, any target color TCₖ (where k=1, 2, 3) is assumed to be a transparent color as will be described later, and as specific values representing the target color TCₖ=(Rₜ, Gₜ, Bₜ), values for the first externally provided target color candidate TCC are used. As the target color candidate TCC, in the case of the housing-case-type transparent display, values that satisfy formulas (8) to (11) are provided, whereas, in the case of the stand-alone-type transparent display, values that satisfy formulas (12) to (15) are provided. Note that instead of determining the target color on the basis of the externally provided target color candidates TCC, the target color TCₖ itself may be externally provided.

Furthermore, the input data judgment portion 202 calculates a target color display area proportion TPₖ for each target color TCₖ. Here, the target color display area proportion Tp is expressed by TPₖ=P/N, where N is the number of all pixels in an input image for the preceding frame period, and P is the number of pixels in a predetermined color range (hereinafter referred to as a “target color range”) TCₖ_{_}_{rg} including a corresponding target color and neighboring colors thereof, among all of the pixels.

The target color TCₖ thus determined and the target color display area proportion TPₖ thereof are provided to the light source data computation portion 206. In accordance with the target color TCₖ and the target color display area proportion TPₖ, the light source data computation portion 206 modifies the light source data initial values Ebₖ, which are initial values for the light emission intensities of the red, green, and blue light sources 40ᵣ, 40_{g}, and 40_{b} during respective subframe periods, thereby generating light source data Eₖ (where k=1 to 3), which indicate the light emission intensities of the red, green, and blue light sources 40ᵣ, 40_{g}, and 40_{b} during the respective subframe periods (the generation of the light source data Eₖ will be described in detail later). Note that the light source data initial value Ebₖ (k=1 to 3) is set such that each subframe period Tₖ corresponds to one of the source colors, each source color corresponds to one of the subframe periods in the same frame period, and in the initial state, the light sources emit light in their corresponding source colors during the respective subframe periods Tₖ (the same applies to other embodiments).

The light source data Eₖ generated by the light source data computation portion 206 is provided to the light source driver portion 210 (see FIG. 1). The light source driver portion 210 drives the light sources 40ᵣ, 40_{g}, and 40_{b} so as to emit source light at the intensities indicated by their corresponding light source data Eₖ during the subframe periods T₁ to T₃ in the following frame period. FIG. 8 shows the case where the light sources emit light with the light source data initial values (i.e., the initial state of the light sources). In this case, only the red light source 40ᵣ emits light during the first subframe period T₁, only the green light source 40_{g} emits light during the second subframe period T₂, and only the blue light source 40_{b} emits light during the third subframe period T₃, but in states other than the initial state, the light source that emits light and the intensity of the light emission are determined by the light source data Eₖ for each subframe period (details will be described later).

By driving the pixel array portion 110 and the light source portion 120 in the above manner, the amounts of transmission of the source light through the pixel forming portions are controlled during the first to third subframe periods T₁ to T₃ on the basis of the modulation data C₁ to C₃, which respectively correspond to the amount of transmission of the source light (in the initial state, the light emitted by the red light source) during the first subframe period T₁, the amount of transmission of the source light (in the initial state, the light emitted by the green light source) during the second subframe period T₂, and the amount of transmission of the source light (in the initial state, the light emitted by the blue light source) during the third subframe period T₃, whereby red, green, and blue images represented by the red, green, and blue image signals Rᵢₙ, Gᵢₙ, and Bᵢₙ are displayed during the respective frame periods. By the field-sequential system as above, a color image represented by an input image signal is displayed on the pixel array portion 110.

Next, referring to FIGS. 7 and 9, generation of the modulation data Cₖ and the light source data Eₖ and operations based on the data Cₖ and Eₖ will be described with respect to the case where the four-subframe-configuration FS system is employed in the present embodiment.

In the case where the four-subframe-configuration FS system is employed, as in the case where the three-subframe-configuration FS system is employed, the liquid crystal display device 10 according to the present embodiment functionally consists of the image display portion 100 and the drive control portion 200, as configured in FIG. 7. However, the modulation data computation portion 212, the input data judgment portion 202, the light source data computation portion 206, etc., operate somewhat differently. The differences will be mainly described below.

In the case of the four-subframe-configuration FS system, each frame period is divided into four subframe periods, i.e., the first to fourth subframe periods T₁ to T₄, as shown in FIG. 9. Here, focusing on two consecutive frame periods, as in the description in conjunction with FIG. 8, the earlier of the two frame periods will be referred to as the “preceding frame period”, and the later one will be referred to as the “following frame period”.

The red, green, and red image signals Rᵢₙ, Gᵢₙ, and Rᵢₙ included in the input image signal in the input signal Dᵢₙ externally received during the preceding frame period are initially provided to the modulation data computation portion 212 and temporarily memorized in the internal memory thereof. The modulation data computation portion 212 separates the input image signal into red, green, and blue chroma components and a white component. More specifically, from the red, green, and red image signals Rᵢₙ, Gᵢₙ, and Rᵢₙ stored in the internal memory, a white-component gradation value W₁ and blue-, green-, and red-chroma-component gradation values B₁, G₁, and R₁ are generated for each pixel by formulas (1) to (4) below. Note that min below represents an operation for obtaining a minimum value.

W₁=min(Rᵢₙ,Gᵢₙ,Bᵢₙ) (1)

B₁=Bᵢₙ−W₁ (2)

G₁=Gᵢₙ−W₁ (3)

R₁=Rᵢₙ−W₁ (4)

Here, the white-component gradation value W₁ can be considered as the value of the white component of the input image signal and corresponds to a combination of the red-, green-, and blue-chroma-component gradation values which are the same as the value W₁. Note that the white-component gradation value W₁, the blue-chroma-component gradation value B₁, the green-chroma-component gradation value G₁, and the red-chroma-component gradation value R₁ for one frame, which are generated as above from the input image signal for the preceding frame period, will be referred to below as white-component gradation data W₁, blue-chroma-component gradation data B₁, green-chroma-component gradation data G₁, and red-chroma-component gradation data R₁, respectively, (the same applies to other embodiments to be described below). The approach based on formulas (1) to (4) above to generating the white-component gradation value W₁ and the blue-, green-, and red-chroma-component gradation values B₁, G₁, and R₁ are illustrative only, and the values for the white component and the red, green, and blue chroma components may be determined by other methods.

The modulation data computation portion 212 generates white, red, green, and blue modulation signals S_{w}, Sᵣ, S_{g}, and S_{b} respectively as signals sequentially indicating their respective sets of white-component gradation values W₁, red-chroma-component gradation values R₁, green-chroma-component gradation values G₁, and blue-chroma-component gradation values B₁. In the present embodiment, the modulation data computation portion 212 outputs the modulation signals S_{w}, Sᵣ, S_{g}, and S_{b} during the first, second, third, and fourth subframe periods T₁, T₂, T₃, and T₄, respectively, of the following frame period, such that the white modulation signal S_{w} serves as first modulation data C₁, the red modulation signal Sᵣ as second modulation data C₂, the green modulation signal S_{g} as third modulation data C₃, and the blue modulation signal S_{b} as fourth modulation data C₄.

The modulation data C₁ to C₄ thus outputted by the modulation data computation portion 212 are provided to the spatial light modulation drive portion 214, such that the first modulation data C₁ serves as a signal indicating transmittance through each pixel forming portion during the first subframe period T₁, the second modulation data C₂ as a signal indicating transmittance through each pixel forming portion during the second subframe period T₂, the third modulation data C₃ as a signal indicating transmittance through each pixel forming portion during the third subframe period T₃, and the fourth modulation data C₄ as a signal indicating transmittance through each pixel forming portion during the fourth subframe period T₄. On the basis of the modulation data C₁ to C₄, the spatial light modulation drive portion 214 drives the pixel array portion 110 during the following frame period.

On the other hand, the input data judgment portion 202 determines a target color TCₖ (where k=1, 2, 3, 4) for each subframe period Tₖ included in the following frame period, on the basis of the externally provided input signal Dᵢₙ. In the case of the four-subframe-configuration FS system, as in the case of the three-subframe-configuration FS system, as a precondition of the determination of the target color TCₖ, one or more colors whose luminances are desired to be increased are designated as candidates for the target color. However, in the present embodiment, any target color TCₖ (where k=1, 2, 3, 4) is assumed to be a transparent color as will be described later, and as specific values representing the target color TCₖ=(Rₜ, Gₜ, Bₜ), values externally provided for one target color candidate TCC are used.

Furthermore, the input data judgment portion 202 calculates a target color display area proportion TPₖ for each target color TCₖ. The target color display area proportion Tp is expressed by TPₖ=P/N, where N is the number of all pixels in an input image during the preceding frame period, and P is the number of pixels in a target color range TCₖ_{_}_{rg}.

The target color TCₖ thus determined and the target color display area proportion TPₖ thereof are provided to the light source data computation portion 206. In accordance with the target color TCₖ and the target color display area proportion TPₖ, the light source data computation portion 206 modifies the light source data initial values, which are initial values for the light emission intensities of the red, green, and blue light sources 40ᵣ, 40_{g}, and 40_{b} during respective subframe periods, thereby generating light source data Eₖ (where k=1, 2, 3, 4), which indicate the light emission intensities of the red, green, and blue light sources 40ᵣ, 40_{g}, and 40_{b} during the respective subframe periods (the generation of the light source data Eₖ will be described in detail later).

The light source data Eₖ generated by the light source data computation portion 206 is provided to the light source driver portion 210 (see FIG. 1). The light source driver portion 210 drives the light sources 40ᵣ, 40_{g}, and 40_{b} so as to emit source light at the intensities indicated by their corresponding light source data Eₖ during the subframe periods T₁ to T₄ in the following frame period. FIG. 9 shows the case where the light sources emit light with the light source data initial values (i.e., the initial state of the light sources). In this case, of the first to fourth subframe periods T₁ to T₄, all of the red, green, and blue light sources 40ᵣ, 40_{g}, and 40_{b} emit light during the first subframe period T₁, whereas only the red light source 40ᵣ emits light during the second subframe period T₂, only the green light source 40_{g} emits light during the third subframe period T₃, and only the blue light source 40; emits light during the fourth subframe period T₄, but in states other than the initial state, the light source that emits light and the intensity of the light emission are determined by the light source data Eₖ for each subframe period (details will be described later).

<1.3 Processing for Generating the Light Source Data>

In the present embodiment, the input data judgment portion 202 performs processing for determining the target color TCₖ for each subframe period (hereinafter, referred to as a “target color determination processing”) and the light source data computation portion 206 performs processing for calculating the light source data Eₖ on the basis of the determined target color and a target color display area proportion TPₖ corresponding thereto (hereinafter, referred to as a “light source data computation processing”). Of these, the light source data computation processing will be described below. Note that the input data judgment portion 202 and the light source data computation portion 206 in the drive control portion 200, along with the modulation data computation portion 212, can be implemented in the form of software through execution of a predetermined program by a microcomputer (hereinafter, abbreviated as a “micom”) including, for example, a CPU (central processing unit) and memory. Alternatively, the entire drive control portion 200 can be implemented as specialized hardware (typically, an application specific integrated circuit designed for specific use).

Furthermore, it is assumed below that each frame period consists of L subframe periods, i.e., first to L'th subframe periods (in the case of the three-subframe configuration, L=3, and in the case of the four-subframe configuration, L=4). In addition, it is also assumed below that output values of the light sources are adjusted so as to achieve a desired color balance when the R-, G-, and B-components in the light source data are equal to one another, and the transparent color refers to a color which maintains such a color ratio (i.e., the ratio of the R-, G-, and B-components).

<1.3.1 Light Source Data Computation Processing>

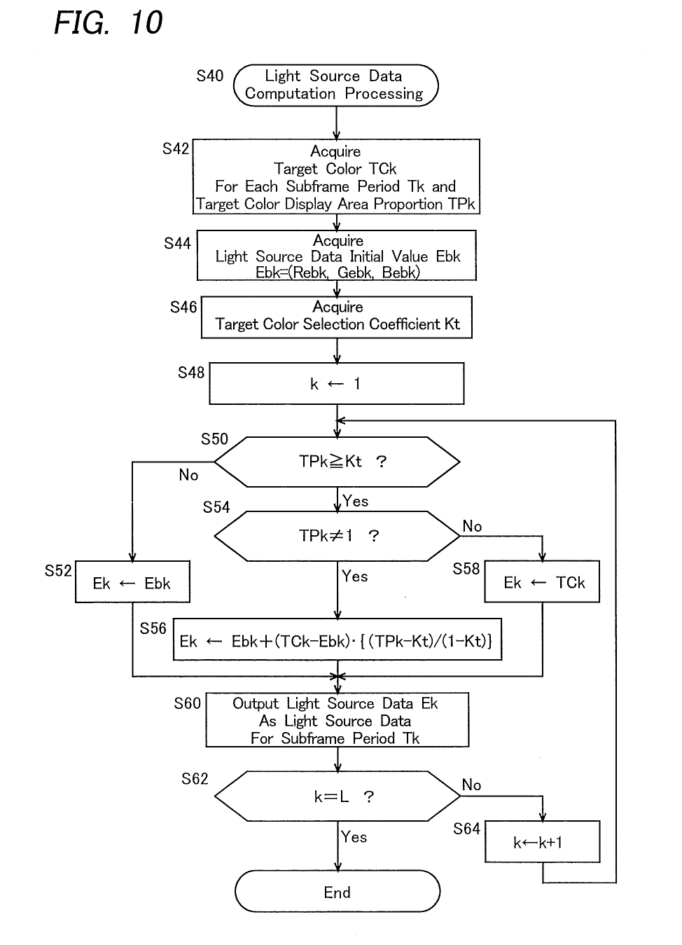

FIG. 10 is a flowchart showing an example of the light source data computation processing executed by the light source data computation portion 206 in the present embodiment. The light source data computation processing is executed every time the input data judgment portion 202 determines the target color TCₖ for each subframe period Tₖ and calculates the target color display area proportion TPₖ=P/N for each target color TCₖ on the basis of the input signal Dᵢₙ (where k=1 to L).

In the light source data computation processing S40, initially, a target color TCₖ for each subframe period Tₖ and a target color display area proportion TPₖ (where k=1 to L) are obtained from the input data judgment portion 202 (step S42), and a light source data initial value Ebₖ is obtained for each subframe period Tₖ from the initial value memory 208 (step S44). Here, the light source data initial value Ebₖ is composed of emission intensities Rebₖ, Gebₖ, and Bebₖ of the red, green, and blue light sources 40ᵣ, 40_{g}, and 40_{b} in the initial state, and expressed by Ebₖ=(Rebₖ, Gebₖ, Bebₖ).

Next, a target color selection coefficient Kₜ is obtained in accordance with a predetermined user operation or predetermined information included in an input signal Dᵢₙ (step S46). The target color selection coefficient Kₜ is externally inputted to the light source data computation portion 206 via an unillustrated signal path in accordance with the predetermined operation or via the input data judgment portion 202 in accordance with the predetermined information included in the input signal Dᵢₙ. The target color selection coefficient Kₜ is used as a threshold for switching calculation formulas for determining light source data Eₖ for each subframe period Tₖ in the following frame period, as will be described later.

Next, the variable k for identifying each subframe period in the following frame period is initialized to “1” (step S48). Thereafter, it is determined whether the target color display area proportion TPₖ for the subframe period Tₖ is greater than or equal to the target color selection coefficient Kₜ (step S50). If the determination result is that the target color display area proportion TPₖ is less than the target color selection coefficient Kₜ, the light source data initial value Ebₖ for the k'th subframe period Tₖ is determined as light source data (hereinafter, also referred to as “k'th drive light source data”) Eₖ to be used for driving the light source portion 120 during the k'th subframe period in the following frame period (step S52). That is, where TPₖ<Kₜ,

Eₖ=Ebₖ (5)

Thereafter, the process advances to step S60.

If the determination result for step S50 is that the target color display area proportion TPₖ is greater than or equal to the target color selection coefficient Kₜ, it is determined whether the target color display area proportion TPₖ is “1” (step S54). If the determination result is that the target color display area proportion TPₖ is not “1”, the k'th drive light source data Eₖ for the following frame period is calculated by the following formula (step S56).

Eₖ=Ebₖ+(TCₖ−Ebₖ){(TPₖ−Kₜ)/(1−Kₜ)} (6)

Here, TCₖ is the target color for the k'th subframe period Tₖ, and Eₖ, Ebₖ, and TCₖ are all composed of three values for R-, G-, and B-components.

If the determination result for step S54 is that the target color display area proportion TPₖ is “1”, the target color TCₖ for the k'th subframe period Tₖ is determined as the k'th drive light source data Eₖ for the following frame period (step S58). That is, where TPₖ=1,

Eₖ=TCₖ (7)

When the k'th drive light source data Eₖ for the following frame period is determined as above, the k'th drive light source data Eₖ is outputted by the light source data computation portion 206 during the k'th subframe period Tₖ in the following frame period (step S60). Thereafter, it is determined whether the variable k is equal to the number L of subframe periods included in one frame period (step S62). If the determination result is that the variable k is not equal to L, i.e., k<L, the process advances to step S64 to increase the variable k by “1” and then returns to step S50. Thereafter, steps S50 to S64 are repeatedly executed until the variable k becomes equal to L, and once the variable k becomes equal to L, the light source data computation processing ends.

<1.3.2 Light Source Data for the Transparent Color>

As described earlier, in the case where the field-sequential system is employed, a transparent display can be realized. The display device according to the present embodiment functions as a transparent display as well. The two configurations, housing-case and stand-alone types, are conceivable for the transparent display in the present embodiment.

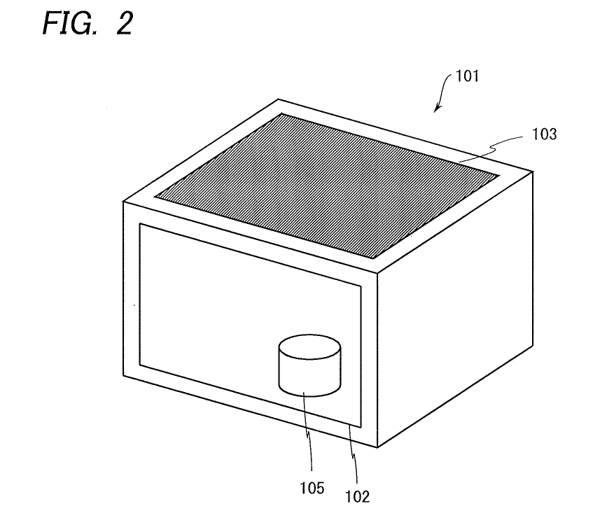

FIG. 2 is a perspective view for describing the configuration of an essential part of the display device 10 according to the present embodiment where the display device 10 is configured as a housing-case-type transparent display (hereinafter, referred to as a “first example”). The display device 10 configured as a housing-case-type transparent display includes a case 101 capable of housing an object, a light source portion 103 provided on a top surface of the case 101 in order to illuminate the inside of the case 101 by sequentially emitting light in R (red), G (green), and B (blue), and a liquid crystal panel 102 (or 11) provided on a front surface of the case 101 in order to display an image in synchronization with the light-emission operation of the light source. In the case of the display device 10, the timing of controlling transmittance through the liquid crystal panel 102 and the timing of the light emission by the light source portion 103 are properly controlled, whereby the red, green, and blue light emitted by the light source portion 103 are transmitted through the liquid crystal panel 102 depending on the transmission state of the liquid crystal panel 102. As a result, the observer can view not only a color image displayed on the liquid crystal panel 102 provided on the front surface of the housing case 101 but also an exhibit 105 disposed inside the housing case 101.

By lighting up the light source, the housing-case-type transparent display as above is rendered in such a display state where light from the back of the liquid crystal panel 102, which serves as a spatial light modulation portion, can be perceived, and the transparency of a display area (transparent display area) in accordance with a transparent color increases with the emission intensity of the light source. Here, the increase or decrease in transparency means the increase or decrease in visibility of the object behind the liquid crystal panel 102. In this case, the light source data (Rₜ, Gₜ, and Bₜ) that correspond to the transparent color are set so as to satisfy the following formulas:

Rₜ=Gₜ=Bₜ (8)

Σ(k=1,L)Rebₖ/L≤Rₜ≤1 (9)

Σ(k=1,L)Gebₖ/L≤Gₜ≤1 (10)

Σ(k=1,L)Bebₖ/L≤Bₜ≤1 (11)

where “Σ(k=k1, k2)Xₖ” represents the sum of Xₖ as k goes from k1 to k2, i.e., Xₖ₁+Xₖ₁₊₁+Xₖ₁₊₂ . . . +Xₖ₂ (the same applies below).

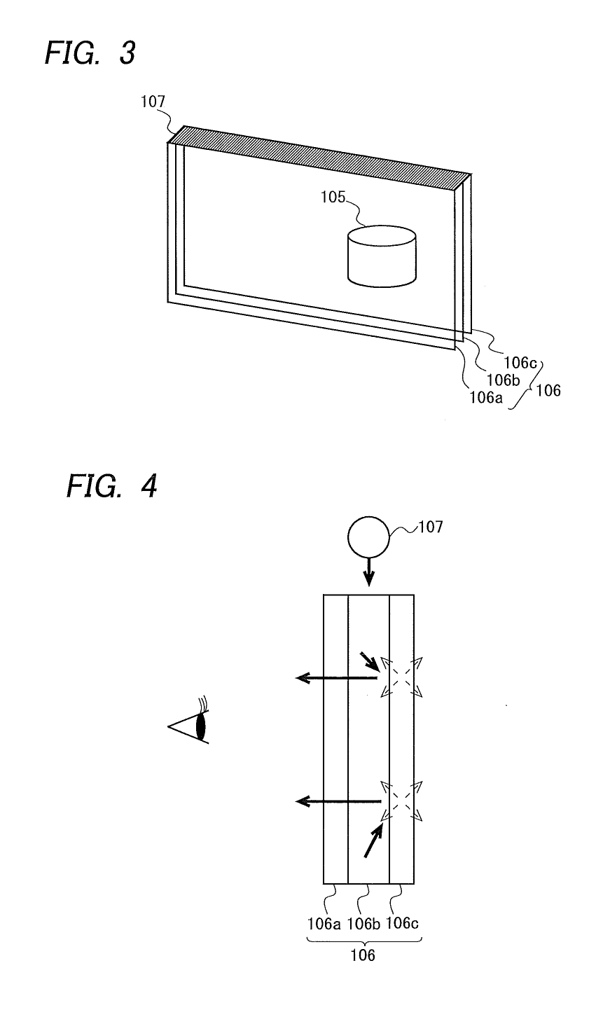

FIG. 3 is a perspective view for describing the configuration of an essential part of the display device 10 according to the present embodiment where the display device 10 is configured as a stand-alone-type transparent display (referred to below as a “second example”), and FIG. 4 is a cross-sectional view for describing the configuration of the essential part of the second example. The display device 10 configured as a stand-alone-type transparent display includes a display panel 106, which consists of a liquid crystal panel 106a, a light guide 106b, and a PDLC (polymer dispersed liquid crystal) panel 106c, and a light source portion 107 of an edge lighting type disposed on an edge surface of the display panel 106 in order to illuminate an edge surface of the light guide 10b by emitting light sequentially in R (red), G (green), and B (blue). In the case of the display device 10, when the PDLC panel 106c is in such a state as to diffuse light (referred to below as a “diffusion state”), as shown in FIG. 4, the timing of controlling transmittance through the liquid crystal panel 106a and the timing of the light emission by the light source portion 107 are properly controlled, whereby an image can be displayed without depending on the background. Moreover, in the case of the display device 10, when the PDLC panel 106c is in such a state as to transmit light therethrough (referred to below as a “transmission state”), light from the light source portion 107 is adjusted so as to be relatively weaker than background light, which is light from the back of the display panel 106, whereby the background light can be perceived to be bright.

By turning off the light source, the stand-alone-type transparent display as above is rendered in such a display state where light from the back of the display panel 106, including the liquid crystal panel 106a, which serves as a spatial light modulation portion, can be perceived, and when the light source is lit up, the transparency of a display area (transparent display area) in accordance with a transparent color increases as the emission intensity of the light source decreases. Here, the increase or decrease in transparency means the increase or decrease in visibility of the object behind the display panel 106, including the liquid crystal panel 106a. In this case, the light source data (Rₜ, Gₜ, and Bₜ) that correspond to the transparent color are set so as to satisfy the following formulas:

Rₜ=Gₜ=Bₜ (12)

Σ(k=1,L)Rebₖ/L≥Rₜ≥0 (13)

Σ(k=1,L)Gebₖ/L≥Gₜ≥0 (14)

Σ(k=1,L)Bebₖ/L≥Bₜ≥0 (15)

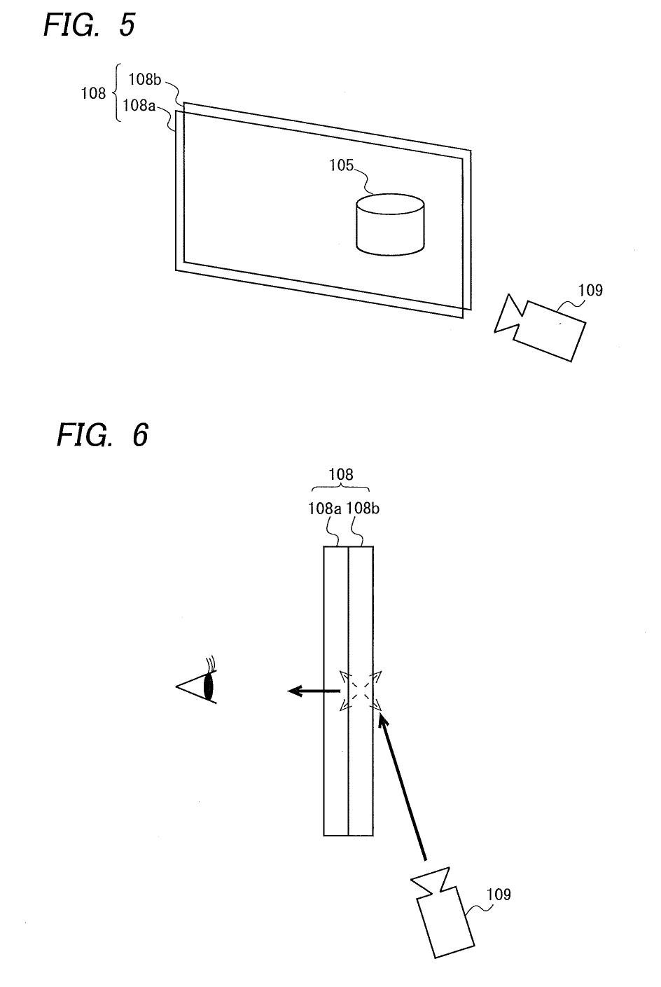

It should be noted that the liquid crystal display device according to the present embodiment may be a stand-alone-type transparent display device with local light emission, as shown in FIGS. 5 and 6. FIG. 5 is a perspective view for describing the configuration of an essential part of the stand-alone-type transparent display device with local light emission, which is a third example of the liquid crystal display device according to the present embodiment, and FIG. 6 is a cross-sectional view for describing the configuration of the essential part of the stand-alone-type transparent display device with local light emission. The stand-alone-type transparent display device with local light emission includes a display panel 108, which consists of a liquid crystal panel 108a and a PDLC panel 108b, and a light source 109 positioned such that the observer cannot directly see source light, and the light source 109 illuminates the PDLC panel 108b, thereby controlling light transmittance through the liquid crystal panel 108a such that an image can be displayed. Moreover, a voltage being applied to the PDLC panel 108b is controlled so as to switch between the transparent state and the display state. In such a stand-alone-type transparent display with local light emission, the source light scatters only in the display portion, and therefore, the observer does not see the source light in the transparent portion. Thus, the source light involved in display does not affect the display state in the transparent portion.

It is assumed below that the present embodiment is configured as any one of the transparent displays described above and that the target color for each subframe period Tₖ is limited to the transparent color that satisfies formulas (8) to (11) or formulas (12) to (15). Accordingly, in the present embodiment, only such a transparent color is provided as a target color candidate TCC and determined as a target color TCₖ, and a target color display area proportion TPₖ corresponding thereto is calculated (where k=1 to L).

<1.4 Processing for Generating the Modulation Data>

As described earlier, in the present embodiment, the modulation data Cₖ is calculated only from the input image signals (the red, green, and blue image signals Rᵢₙ, Gᵢₙ, and Bᵢₙ) and does not depend on the target color TCₖ and other factors. Specifically, in the case of the three-subframe-configuration FS system,

C₁=Sᵣ, C₂=S_{g}, C₃=S_{b} (16),

whereas in the case of the four-subframe-configuration FS system,

C₁=S_{w}, C₂=Sᵣ, C₃=S_{g}, C₄=S_{b} (17)

Here, C₁ to C_{L} represent transmittance and therefore are assumed to be normalized such that 0≤Cₖ≤1 (where k=1 to L). Moreover, in the case where a transparent color is displayed, for all of the subframe periods T₁ to T_{L}, the modulation data C₁ to C_{L} for the transparent display area are set so as to maximize backlight transmission through the liquid crystal panel 102 (or 106a), which serves as a spatial light modulation portion.

<1.5 Color Reproduction Range>

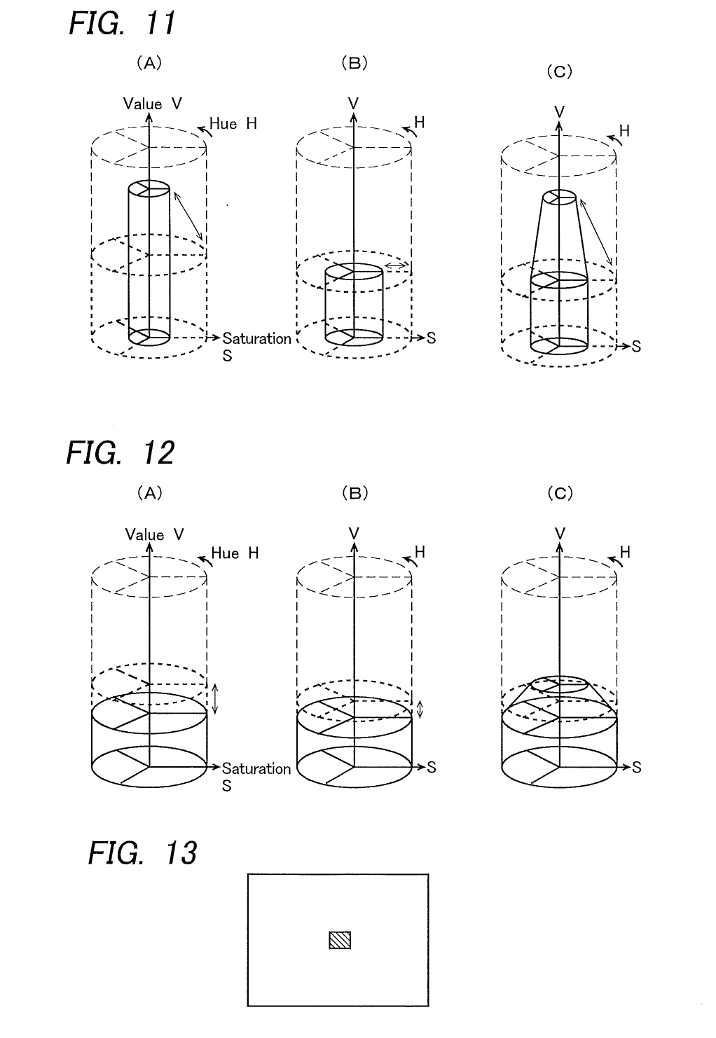

FIG. 11 provides conceptual diagrams for describing the color reproduction range in HSV color space where the display device according to the present embodiment is a housing-case-type transparent display employing any of the first through third field-sequential systems. Here, the first field-sequential system corresponds to the simple RGB subframe system employing a three-subframe configuration. The second field-sequential system corresponds to the RGB+W subframe system (or the common color subframe system) employing a four-subframe configuration. The third field-sequential system corresponds to a variant of the RGB+W subframe system (or the common color subframe system) employing a four-subframe configuration, where white is displayed during all subframe periods.

FIG. 11 illustrates changes of the color reproduction range due to variable parameters for the light source data computation processing in the present embodiment where (A) the first field-sequential system is employed, (B) the second field-sequential system is employed, and (C) the third field-sequential system is employed. More specifically, in the light source data computation processing, when the target color TCₖ or the target color selection coefficient Kₜ changes depending on the target color candidate, the color reproduction range changes between an area defined by bold dotted lines and an area defined by bold lines in each of (A), (B), and (C) of FIG. 11.

FIG. 12 provides conceptual diagrams for describing the color reproduction range in HSV color space where the display device according to the present embodiment is a stand-alone-type transparent display employing any of the first through third field-sequential systems. FIG. 12 illustrates changes of the color reproduction range due to variable parameters for the light source data computation processing in the present embodiment where (A) the first field-sequential system is employed, (B) the second field-sequential system is employed, and (C) the third field-sequential system is employed. More specifically, in the light source data computation processing, when the target color TCₖ or the target color selection coefficient Kₜ changes depending on the target color candidate, the color reproduction range changes between an area defined by bold dotted lines and an area defined by bold lines in each of (A), (B), and (C) of FIG. 12.

<1.6 Effects>

As described above, in the present embodiment, a transparent color externally designated as a target color candidate TCC is determined as a target color TCₖ for each subframe period Tₖ (where k=1 to L). In this case, values for the target color candidate TCC are used as specific values representing each target color TCₖ=(R₁, Gₜ, Bₜ). On the basis of the target color TCₖ thus determined, a target color display area proportion TPₖ for the target color TCₖ, a light source data initial value Ebₖ, and a target color selection coefficient Kₜ, light source data Eₖ is determined for each subframe period Tₖ (by formulas (5) to (7)), and the state of the light source (the type (color) and the intensity of the light source to be lit up) is determined for each subframe period Tₖ in accordance with the determined light source data Eₖ. Moreover, as described earlier, for each subframe period Tₖ, modulation data Cₖ is determined by input image signals included in an input signal Dᵢₙ, but in the case where a transparent color is displayed, for all subframe periods T₁ to T_{L}, modulation data C₁ to C_{L} for a display area to be rendered in the transparent color (i.e., a transparent display area) are set so as to maximize backlight transmission through the spatial light modulation portion. Accordingly, the present embodiment renders it possible to inhibit a reduction in saturation of a display color as much as possible while achieving enhanced visible luminance of background light, i.e., transparency, in the transparent display area, whereby color breakup due to the field-sequential system can be inhibited.

<1.7 Description of the Effects by Specific Examples>

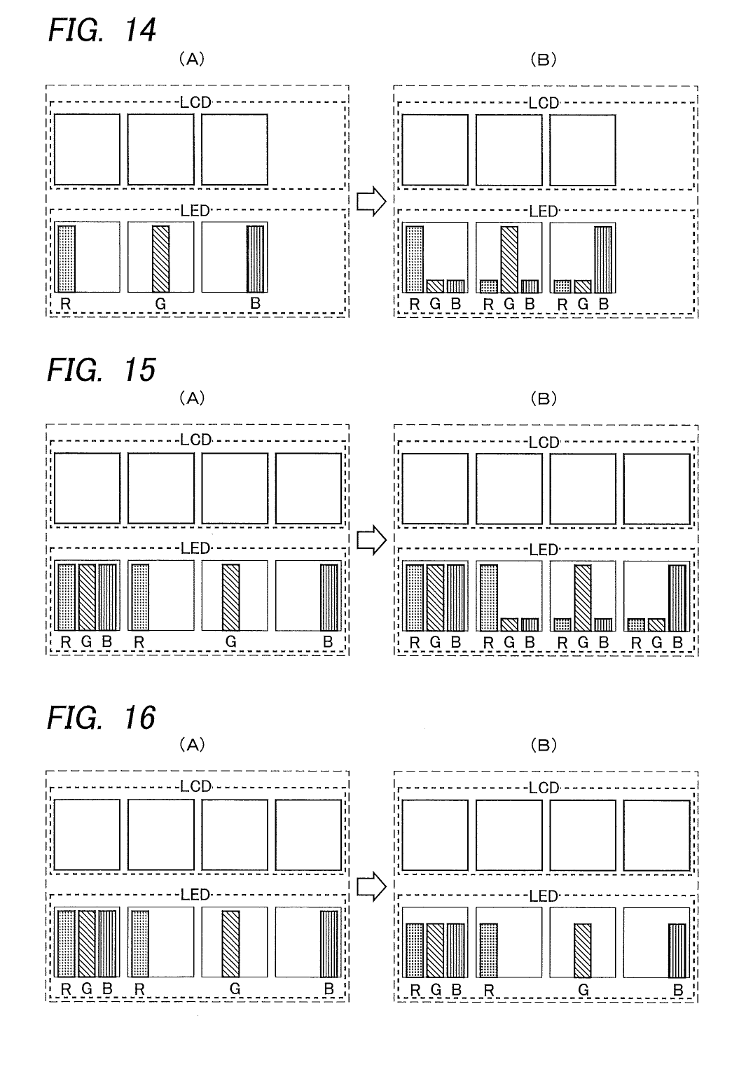

It is assumed below that in a current image as shown in FIG. 13, a green area represented by (R, G, B)=(0, 1, 0) constitutes 4%, and a transparent color area constitutes 96%. It is assumed here that three values for R-, G-, and B-components, which specify colors, correspond to values specifying light source data (the same applies to other embodiments to be described below). Note that in each operation example to be described below, each target color TCₖ is provided as an operating condition, and values for an externally provided target color candidate TCC are used as specific values for the target color TCₖ=(Rₜ, Gₜ, Bₜ).

<1.7.1 First Operation Example (FIG. 14)>

In the present operation example, a housing-case-type transparent display in accordance with the three-subframe-configuration FS system operates under the following conditions:

(1a) the target selection coefficient is such that Kₜ=0.95;

(1b) the light source data initial values Ebₖ(where k=1 to 3) are as follows:

Eb₁=(1, 0, 0), Eb₂=(0, 1, 0), and Eb₃=(0, 0, 1); and

(1c) the target color TCₖ (where k=1 to 3) is a transparent color shown below. Here, the target color candidate, which is the transparent color, is such that TCC=(1, 1, 1):

TC₁=TC₂=TC₃=(1, 1, 1).

Under conditions (1a) to (1c), the light source data Eₖ in the present embodiment is generated as described below. Note that condition (1c) satisfies formulas (8) to (11) presupposing the housing-case-type transparent display (i.e., the first example).

In the present operation example, for the transparent color (1, 1, 1), which is the target color, the target color display area proportion TP₁=TP₂=TP₃ is 0.96, and the target color selection coefficient is such that Kₜ=0.95, hence TPₖ>Kₜ (where k=1 to 3). Accordingly, from formula (6), the light source data Eₖ is obtained as below. Note that the R-, G-, and B-components of the light source data Eₖ will be denoted below respectively by R(Eₖ), G(Eₖ), and B(Eₖ) (the same applies below).

R(E₁)=1+(1−1){(0.96−0.95)/(1−0.95)}=1

G(E₁)=0+(1−0){(0.96−0.95)/(1−0.95)}=0.2

B(E₁)=0+(1−0){(0.96−0.95)/(1−0.95)}=0.2

R(E₂)=0+(1−0){(0.96−0.95)/(1−0.95)}=0.2

G(E₂)=1+(1−1){(0.96−0.95)/(1−0.95)}=1

B(E₂)=0+(1−0){(0.96−0.95)/(1−0.95)}=0.2

R(E₃)=0+(1−0){(0.96−0.95)/(1−0.95)}=0.2

G(E₃)=0+(1−0){(0.96−0.95)/(1−0.95)}=0.2

B(E₃)=1+(1−1){(0.96−0.95)/(1−0.95)}=1

Accordingly, E₁=(1, 0.2, 0.2), E₂=(0.2, 1, 0.2), and E₃=(0.2, 0.2, 1). Note that the modulation data Cₖ for the display area of the transparent color (1, 1, 1) is 1 (where k=1 to 3).

As is evident from the above, in the present operation example, the operation is initially in a state as shown in (A) of FIG. 14, but under conditions (1a) to (1c), the operation is in a state as shown in (B) of FIG. 14. In each of (A) and (B) of FIG. 14, transmittance through (a sample of pixels of) the liquid crystal panel and the state of the light source (the type (color) and the intensity of the light source to be lit up) are shown for each of the following: sequentially from left to right, the first subframe period T₁, the second subframe period T₂, and the third subframe period T₃ (the same applies to FIG. 17 to be described later). More specifically, rectangular portions enclosed by bold dotted lines and denoted by “LCD” represent the transmittance through the liquid crystal panel for the subframe periods Tₖ, and rectangular portions enclosed by bold dotted lines and denoted by “LED” represent the states of the light source for the subframe periods Tₖ (the same applies to FIGS. 15 to 22 to be described later).

As shown in (B) of FIG. 14, during the first subframe period T₁, the red light source (i.e., the red LED 40ᵣ) emits light at a maximum intensity, and the green light source (i.e., the green LED 40_{g}) and the blue light source (i.e., the blue LED 40_{b}) emit light at 20% of the maximum intensity; during the second subframe period T₂, the green light source emits light at the maximum intensity, and the red and blue light sources emit light at 20% of the maximum intensity; and during the third subframe period T₃, the blue light source emits light at the maximum intensity, and the red and green light sources emit light at 20% of the maximum intensity.

In the case where most (96%) of the area of an image to be displayed (i.e., a current image) is displayed in a transparent display mode, as shown in FIG. 13, color breakup in the transparent display area poses a problem more than does saturation in the display area other than the transparent display area (hereinafter, referred to as the “color display area”). In this regard, in the present embodiment, the light source state in the first operation example shown in (B) of FIG. 14 enhances the transparency of the transparent display area and reduces color breakup, but instead, saturation in the color display area decreases (see (A) of FIG. 11).

<1.7.2 Second Operation Example (FIG. 15)>

In the present operation example, a housing-case-type transparent display in accordance with the four-subframe-configuration FS system operates under the following conditions:

(2a) the target selection coefficient is such that Kₜ=0.95;

(2b) the light source data initial values Ebₖ(where k=1 to 4) are as follows:

Eb₁=(1, 1, 1), Eb₂=(1, 0, 0), Eb₃=(0, 1, 0), and Eb₄=(0, 0, 1); and

(2c) the target color TCₖ (where k=1 to 4) is a transparent color shown below. Here, the target color candidate, which is the transparent color, is such that TCC=(1, 1, 1):

TC₁=TC₂=TC₃=TC₄=(1, 1, 1).

Under conditions (2a) to (2c), the light source data Eₖ in the present embodiment is generated as described below. Specifically, as in the first operation example, for the transparent color (1, 1, 1), which is the target color, the target color display area proportion TP₁=TP₂=TP₃=TP₄ is 0.96, and the target color selection coefficient is Kₜ=0.95, hence TPₖ>Kₜ (where k=1 to 4). Accordingly, from formula (6), the R-, G-, and B-components of the light source data Eₖ are obtained as below.

R(E₁)=1+(1−1){(0.96−0.95)/(1−0.95)}=1

G(E₁)=1+(1−1){(0.96−0.95)/(1−0.95)}=1

B(E₁)=1+(1−1){(0.96−0.95)/(1−0.95)}=1

R(E₂)=1+(1−1){(0.96−0.95)/(1−0.95)}=1

G(E₂)=0+(1−0){(0.96−0.95)/(1−0.95)}=0.2

B(E₂)=0+(1−0){(0.96−0.95)/(1−0.95)}=0.2

R(E₃)=0+(1−0){(0.96−0.95)/(1−0.95)}=0.2

G(E₃)=1+(1−1){(0.96−0.95)/(1−0.95)}=1

B(E₃)=0+(1−0){(0.96−0.95)/(1−0.95)}=0.2

R(E₄)=0+(1−0){(0.96−0.95)/(1−0.95)}=0.2

G(E₄)=0+(1−0){(0.96−0.95)/(1−0.95)}=0.2

B(E₄)=1+(1−1){(0.96−0.95)/(1−0.95)}=1

Accordingly, E₁=(1, 1, 1), E₂=(1, 0.2, 0.2), E₃=(0.2, 1, 0.2), and E₄=(0.2, 0.2, 1). Note that the modulation data Cₖ for the display area of the transparent color (1, 1, 1) is 1 (where k=1 to 4).

As is evident from the above, in the present operation example, the operation is initially in a state as shown in (A) of FIG. 15, but under conditions (2a) to (2c), the operation is in a state as shown in (B) of FIG. 15. In each of (A) and (B) of FIG. 15, transmittance through (a sample of pixels of) the liquid crystal panel and the state of the light source (the type (color) and the intensity of the light source to be lit up) are shown for each of the following: sequentially from left to right, the first subframe period T₁, the second subframe period T₂, the third subframe period T₃, and the fourth subframe period T₄ (the same applies to FIGS. 16 and 18 to 22 to be described later).

As shown in (B) of FIG. 15, during the first subframe period T₁, all of the red, green, and blue light sources emit light at a maximum intensity; during the second subframe period T₂, the red light source emits light at the maximum intensity, and the green and blue light sources emit light at 20% of the maximum intensity; during the third subframe period T₃, the green light source emits light at the maximum intensity, and the red and blue light sources emit light at 20% of the maximum intensity; and during the fourth subframe period T₄, the blue light source emits light at the maximum intensity, and the red and green light sources emit light at 20% of the maximum intensity.

In the case where most (96%) of the area of an image to be displayed (i.e., a current image) is displayed in the transparent display mode, as shown in FIG. 13, color breakup in the transparent display area poses a problem more than does saturation in the color display area. In this regard, in the present embodiment, the light source state in the second operation example shown in (B) of FIG. 15 enhances the transparency of the transparent display area and reduces color breakup, but instead, saturation in the color display area decreases (see (C) of FIG. 11).

<1.7.3 Third Operation Example (FIG. 16)>

In the present operation example, a stand-alone-type transparent display in accordance with the four-subframe-configuration FS system operates under the following conditions:

(3a) the target selection coefficient is such that Kₜ=0.95;

(3b) the light source data initial values Ebₖ(where k=1 to 4) are as follows:

Eb₁=(1, 1, 1), Eb₂=(1, 0, 0), Eb₃=(0, 1, 0), and Eb₄=(0, 0, 1); and

(3c) the target color TCₖ (where k=1 to 4) is a transparent color shown below. Here, the target color candidate, which is the transparent color, is such that TCC=(0, 0, 0):

TC₁=TC₂=TC₃=TC₄=(0, 0, 0).

Under conditions (3a) to (3c), the light source data Eₖ in the present embodiment is generated as described below. Specifically, in the present operation example, for the transparent color (0, 0, 0), which is the target color, the target color display area proportion TP₁=TP₂=TP₃=TP₄ is 0.96, and the target color selection coefficient is such that Kₜ=0.95, hence TPₖ>Kₜ (where k=1 to 4). Accordingly, from formula (6), the R-, G-, and B-components of the light source data Eₖ are obtained as below.

R(E₁)=1+(0−1){(0.96−0.95)/(1−0.95)}=0.8

G(E₁)=1+(0−1){(0.96−0.95)/(1−0.95)}=0.8

B(E₁)=1+(0−1){(0.96−0.95)/(1−0.95)}=0.8

R(E₂)=1+(0−1){(0.96−0.95)/(1−0.95)}=0.8

G(E₂)=0+(0−0){(0.96−0.95)/(1−0.95)}=0

B(E₂)=0+(0−0){(0.96−0.95)/(1−0.95)}=0

R(E₃)=0+(0−0){(0.96−0.95)/(1−0.95)}=0

G(E₃)=1+(0−1){(0.96−0.95)/(1−0.95)}=0.8

B(E₃)=0+(0−0){(0.96−0.95)/(1−0.95)}=0

R(E₄)=0+(0−0){(0.96−0.95)/(1−0.95)}=0

G(E₄)=0+(0−0){(0.96−0.95)/(1−0.95)}=0

B(E₄)=1+(0−1){(0.96−0.95)/(1−0.95)}=0.8

Accordingly, E₁=(0.8, 0.8, 0.8), E₂=(0.8, 0, 0), E₃=(0, 0.8, 0), and E₄=(0, 0, 0.8). Note that the modulation data Cₖ for the display area of the transparent color (0, 0, 0) is 1 (where k=1 to 4).

As evident from the above, in the present operation example, the operation is initially in a state as shown in (A) of FIG. 16, but under conditions (3a) to (3c), the operation is in a state as shown in (B) of FIG. 16. As shown in (B) of FIG. 16, during the first subframe period T₁, all of the red, green, and blue light sources emit light at 80% of a maximum intensity; during the second subframe period T₂, the red light source emits light at 80% of the maximum intensity; during the third subframe period T₃, the green light source emits light at 80% of the maximum intensity; and during the fourth subframe period T₄, the blue light source emits light at 80% of the maximum intensity.

In the case of the stand-alone-type transparent display, to allow background light to appear brighter, it is necessary to weaken light from the light source (see FIGS. 3 and 4), and therefore, in the case where most (96%) of the area of an image to be displayed (i.e., a current image) is displayed in the transparent display mode, as shown in FIG. 13, low transparency of the transparent display area poses a problem more than does the brightness of the color display area. In this regard, in the present embodiment, the light source state in the third operation example shown in (B) of FIG. 16 enhances the transparency of the transparent display area and reduces color breakup, but instead, the luminance of the color display area decreases (see (C) of FIG. 12).

<1.7.4 Fourth Operation Example (FIG. 17)>

In the present operation example, a housing-case-type transparent display in accordance with the three-subframe-configuration FS system operates under the following conditions:

(4a) the target selection coefficient is such that Kₜ=0.95;

(4b) the light source data initial values Ebₖ(where k=1 to 3) are as follows:

Eb₁=(1, 0, 0), Eb₂=(0, 1, 0), and Eb₃=(0, 0, 1); and

(4c) the target color TCₖ (where k=1 to 3) is a transparent color shown below. Here, the target color candidate, which is the transparent color, is such that TCC=(0.5, 0.5, 0.5):

TC₁=TC₂=TC₃=(0.5, 0.5, 0.5).

Under conditions (4a) to (4c), the light source data Eₖ in the present embodiment is generated as described below. Note that condition (4c) satisfies formulas (8) to (11) presupposing the housing-case-type transparent display (i.e., the first example).

In the present operation example, for the transparent color (0.5, 0.5, 0.5), which is the target color, the target color display area proportion TP₁=TP₂=TP₃ is 0.96, and the target color selection coefficient is such that Kₜ=0.95, hence TPₖ>Kₜ (where k=1 to 3). Accordingly, from formula (6), the R-, G-, and B-components of the light source data Eₖ are obtained as below.

R(E₁)=1+(0.5−1){(0.96−0.95)/(1−0.95)}=0.9

G(E₁)=0+(0.5−0){(0.96−0.95)/(1−0.95)}=0.1

B(E₁)=0+(0.5−0){(0.96−0.95)/(1−0.95)}=0.1

R(E₂)=0+(0.5−0){(0.96−0.95)/(1−0.95)}=0.1

G(E₂)=1+(0.5−1){(0.96−0.95)/(1−0.95)}=0.9

B(E₂)=0+(0.5−0){(0.96−0.95)/(1−0.95)}=0.1

R(E₃)=0+(0.5−0){(0.96−0.95)/(1−0.95)}=0.1

G(E₃)=0+(0.5−0){(0.96−0.95)/(1−0.95)}=0.1

B(E₃)=1+(0.5−1){(0.96−0.95)/(1−0.95)}=0.9

Accordingly, E₁=(0.9, 0.1, 0.1), E₂=(0.1, 0.9, 0.1), and E₃=(0.1, 0.1, 0.9). Note that the modulation data Cₖ for the display area of the transparent color (0.5, 0.5, 0.5) is 1.

As is evident from the above, in the present operation example, the operation is initially in a state as shown in (A) of FIG. 17, but under conditions (4a) to (4c), the operation is in a state as shown in (B) of FIG. 17. As shown in (B) of FIG. 17, during the first subframe period T₁, the red light source emits light at 90% of a maximum intensity, and the green and blue light sources emit light at 10% of the maximum intensity; during the second subframe period T₂, the green light source emits light at 90% of the maximum intensity, and the red and blue light sources emit light at 10% of the maximum intensity; and during the third subframe period T₃, the blue light source emits light at 90% of the maximum intensity, and the red and green light sources emit light at 10% of the maximum intensity.

In the case where most (96%) of the area of an image to be displayed (i.e., a current image) is displayed in the transparent display mode, as shown in FIG. 13, color breakup in the transparent display area poses a problem more than does saturation in the color display area. In this regard, in the present embodiment, the light source state in the fourth operation example shown in (B) of FIG. 17 enhances the transparency of the transparent display area and reduces color breakup, but instead, saturation in the color display area decreases (see (A) of FIG. 11).

<1.7.5 Fifth Operation Example (FIG. 18)>

In the present operation example, a housing-case-type or stand-alone-type transparent display in accordance with the four-subframe-configuration FS system operates under the following conditions:

(5a) the target selection coefficient is such that Kₜ=0.95;

(5b) the light source data initial values Ebₖ(where k=1 to 4) are as follows:

Eb₁=(1, 1, 1), Eb₂=(1, 0, 0), Eb₃=(0, 1, 0), and Eb₄=(0, 0, 1); and

(5c) the target color TCₖ (where k=1 to 4) is a transparent color shown below. Here, the target color candidate, which is the transparent color, is such that TCC=(0.5, 0.5, 0.5):

TC₁=TC₂=TC₃=TC₄=(0.5, 0.5, 0.5).

Under conditions (5a) to (5c), the light source data Eₖ in the present embodiment is generated as described below. Note that condition (5c) satisfies formulas (8) to (11) presupposing the housing-case-type transparent display (i.e., the first example) and formulas (12) to (15) presupposing the stand-alone-type transparent display (i.e., the second example).

In the present operation example, for the transparent color (0.5, 0.5, 0.5), which is the target color, the target color display area proportion TP₁=TP₂=TP₃=TP₄ is 0.96, and the target color selection coefficient is such that Kₜ=0.95, hence TPₖ>Kₜ (where k=1 to 4). Accordingly, from formula (6), the R-, G-, and B-components of the light source data Eₖ are obtained as below.

R(E₁)=1+(0.5−1){(0.96−0.95)/(1−0.95)}=0.9

G(E₁)=1+(0.5−1){(0.96−0.95)/(1−0.95)}=0.9

B(E₁)=1+(0.5−1){(0.96−0.95)/(1−0.95)}=0.9

R(E₂)=1+(0.5−1){(0.96−0.95)/(1−0.95)}=0.9

G(E₂)=0+(0.5−0){(0.96−0.95)/(1−0.95)}=0.1

B(E₂)=0+(0.5−0){(0.96−0.95)/(1−0.95)}=0.1

R(E₃)=0+(0.5−0){(0.96−0.95)/(1−0.95)}=0.1

G(E₃)=1+(0.5−1){(0.96−0.95)/(1−0.95)}=0.9

B(E₃)=0+(0.5−0){(0.96−0.95)/(1−0.95)}=0.1

R(E₄)=0+(0.5−0){(0.96−0.95)/(1−0.95)}=0.1

G(E₄)=0+(0.5−0){(0.96−0.95)/(1−0.95)}=0.1

B(E₄)=1+(0.5−1){(0.96−0.95)/(1−0.95)}=0.9

Accordingly, E₁=(0.9, 0.9, 0.9), E₂=(0.9, 0.1, 0.1), E₃=(0.1, 0.9, 0.1), and E₄=(0.1, 0.1, 0.9). Note that the modulation data Cₖ for the display area of the transparent color (0.5, 0.5, 0.5) is 1 (where k=1 to 4).

As is evident from the above, in the present operation example, the operation is initially in a state as shown in (A) of FIG. 18, but under conditions (5a) to (5c), the operation is in a state as shown in (B) of FIG. 18. As shown in (B) of FIG. 18, during the first subframe period T₁, all of the red, green, and blue light sources emit light at 90% of a maximum intensity; during the second subframe period T₂, the red light source emits light at 90% of the maximum intensity, and the green and blue light sources emit light at 10% of the maximum intensity; during the third subframe period T₃, the green light source emits light at 90% of the maximum intensity, and the red and blue light sources emit light at 10% of the maximum intensity; and during the fourth subframe period T₄, the blue light source emits light at 90% of the maximum intensity, and the red and green light sources emit light at 10% of the maximum intensity.

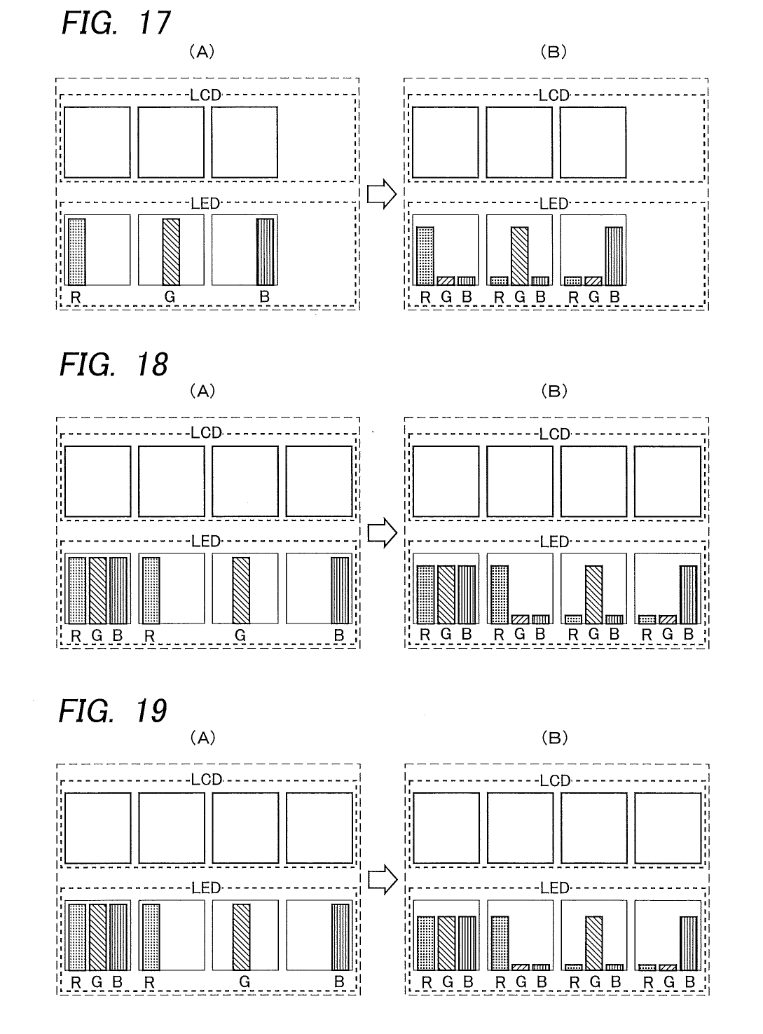

In the case where most (96%) of the area of an image to be displayed (i.e., a current image) is displayed in the transparent display mode, as shown in FIG. 13, color breakup in the transparent display area poses a problem more than does saturation in the color display area. In this regard, in the present embodiment, the light source state in the fifth operation example shown in (B) of FIG. 18 maintains the transparency of the transparent display area and reduces color breakup, but instead, saturation in the color display area decreases (see (C) of FIG. 11 and (C) of FIG. 12).

<1.7.6 Sixth Operation Example (FIG. 19)>

In the present operation example, a stand-alone-type transparent display in accordance with the four-subframe-configuration FS system operates under the following conditions:

(6a) the target selection coefficient is such that Kₜ=0.95;

(6b) the light source data initial values Ebₖ(where k=1 to 4) are as follows:

Eb₁=(1, 1, 1), Eb₂=(1, 0, 0), Eb₃=(0, 1, 0), and Eb₄=(0, 0, 1); and

(6c) the target color TCₖ (where k=1 to 4) is a transparent color shown below. Here, the target color candidate, which is the transparent color, is such that TCC=(0.25, 0.25, 0.25):

TC₁=TC₂=TC₃=TC₄=(0.25, 0.25, 0.25).

Under conditions (6a) to (6c), the light source data Eₖ in the present embodiment is generated as described below. Note that condition (6c) satisfies formulas (12) to (15) presupposing the stand-alone-type transparent display (i.e., the second example).

In the present operation example, for the transparent color (0.25, 0.25, 0.25), which is the target color, the target color display area proportion TP₁=TP₂=TP₃=TP₄ is 0.96, and the target color selection coefficient is such that Kₜ=0.95, hence TPₖ>Kₜ (where k=1 to 4). Accordingly, from formula (6), the R-, G-, and B-components in the light source data Eₖ are obtained as below.

R(E₁)=1+(0.25−1){(0.96−0.95)/(1−0.95)}=0.85

G(E₁)=1+(0.25−1){(0.96−0.95)/(1−0.95)}=0.85

B(E₁)=1+(0.25−1){(0.96−0.95)/(1−0.95)}=0.85

R(E₂)=1+(0.25−1){(0.96−0.95)/(1−0.95)}=0.85

G(E₂)=0+(0.25−0){(0.96−0.95)/(1−0.95)}=0.05

B(E₂)=0+(0.25−0){(0.96−0.95)/(1−0.95)}=0.05

R(E₃)=0+(0.25−0){(0.96−0.95)/(1−0.95)}=0.05

G(E₃)=1+(0.25−1){(0.96−0.95)/(1−0.95)}=0.85

B(E₃)=0+(0.25−0){(0.96−0.95)/(1−0.95)}=0.05

R(E₄)=0+(0.25−0){(0.96−0.95)/(1−0.95)}=0.05

G(E₄)=0+(0.25−0){(0.96−0.95)/(1−0.95)}=0.05

B(E₄)=1+(0.25−1){(0.96−0.95)/(1−0.95)}=0.85

Accordingly, E₁=(0.85, 0.85, 0.85), E₂=(0.85, 0.05, 0.05), E₂=(0.05, 0.85, 0.05), and E₄=(0.05, 0.05, 0.85). Note that the modulation data Cₖ for the display area of the transparent color (0.25, 0.25, 0.25) is 1 (where k=1 to 4).

As is evident from the above, in the present operation example, the operation is initially in a state as shown in (A) of FIG. 19, but under conditions (6a) to (6c), the operation is in a state as shown in (B) of FIG. 19. As shown in (B) of FIG. 19, during the first subframe period T₁, all of the red, green, and blue light sources emit light at 85% of a maximum intensity; during the second subframe period T₂, the red light source emits light at 85% of the maximum intensity, and the green and blue light sources emit light at 5% of the maximum intensity; during the third subframe period T₃, the green light source emits light at 85% of the maximum intensity, and the red and blue light sources emit light at 5% of the maximum intensity; and during the fourth subframe period T₄, the blue light source emits light at 85% of the maximum intensity, and the red and green light sources emit light at 5% of the maximum intensity.

In the case of the stand-alone-type transparent display, to allow background light to appear brighter, it is necessary to weaken light from the light source (see FIGS. 3 and 4), and therefore, in the case where most (96%) of the area of an image to be displayed (i.e., a current image) is displayed in the transparent display mode, as shown in FIG. 13, low transparency of the transparent display area poses a problem more than does the brightness of the color display area. In this regard, in the present embodiment, the light source state in the sixth operation example shown in (B) of FIG. 19 enhances the transparency of the transparent display area and reduces color breakup, but instead, the luminance of the color display area decreases (see (C) of FIG. 12).

### 2. Second Embodiment

Next, a field-sequential liquid crystal display device according to a second embodiment of the present invention will be described. The present embodiment differs from the first embodiment in the target color determination processing by the input data judgment portion in the control drive portion, but the other features are the same as in the first embodiment. Accordingly, in the following, elements of the present embodiment that are the same as or correspond to the elements of the first embodiment are denoted by the same reference characters and any detailed descriptions thereof will be omitted.

<2.1 Target Color Determination Processing>

In the present embodiment, the input data judgment portion 202 determines a target color TCₖ (where k=1 to L) as below. The present embodiment and the first embodiment are the same in that as a target color candidate TCC=(Rₜ, Gₜ, B_{L}), a transparent color that satisfies formulas (8) to (11) is provided in the case of the housing-case-type transparent display, whereas a transparent color that satisfies formulas (12) to (15) is provided in the case of the stand-alone-type transparent display. However, in the present embodiment, the target color candidate TCC is not a target color TCₖ (where k=1 to L) for each subframe period Tₖ, but the target color candidate TCC (which is a transparent color) is determined as a target color TCₛ for a subframe period Tₛ corresponding to a light source data initial value Ebₛ for which saturation is minimum among all light source data initial values Eb₁ to Eb_{L}, and each of the light source data initial values Ebⱼ other than the light source data initial value Ebₛ is determined as a target color TCⱼ for a corresponding subframe period Tⱼ (here, j is an integer which satisfies 1≤j≤L and j≠s). Note that for each target color TCₖ, a target color display area proportion TPₖ is obtained in the same manner as in the first embodiment.

<2.2 Effects>

As described above, in the present embodiment, the transparent color that satisfies formulas (8) to (11) or formulas (12) to (15) and the light source data initial values Ebₖ which correspond to chromatic colors (or for which saturation is not minimum) are determined as target colors TCₖ for respectively corresponding subframe periods Tₖ; based on the light source data initial value Ebₖ, the target color TCₖ, the target color display area proportion TPₖ, and the target color selection coefficient Kₜ, the light source data Eₖ is determined for each subframe period Tₖ (by formulas (5) to (7)), and in accordance with the determined light source data Eₖ, the state of the light source (the type (color) and the intensity of the light source to be lit up) for the subframe period Tₖ is determined. Moreover, as described earlier, for each subframe period Tₖ, modulation data Cₖ is determined by an input image signal included in an input signal Dᵢₙ, and in the case where a transparent color is displayed, for all subframe periods T₁ to T_{L}, modulation data C₁ to C_{L} for the transparent display area are set so as to maximize backlight transmission through the spatial light modulation portion. Accordingly, the present embodiment renders it possible to enhance visible luminance of background light, i.e., transparency, in the transparent display mode without reducing saturation of a simple color (i.e., a chromatic color of any light source), while inhibiting as much color breakup as possible.

<2.3 Description of the Effects by Specific Examples>

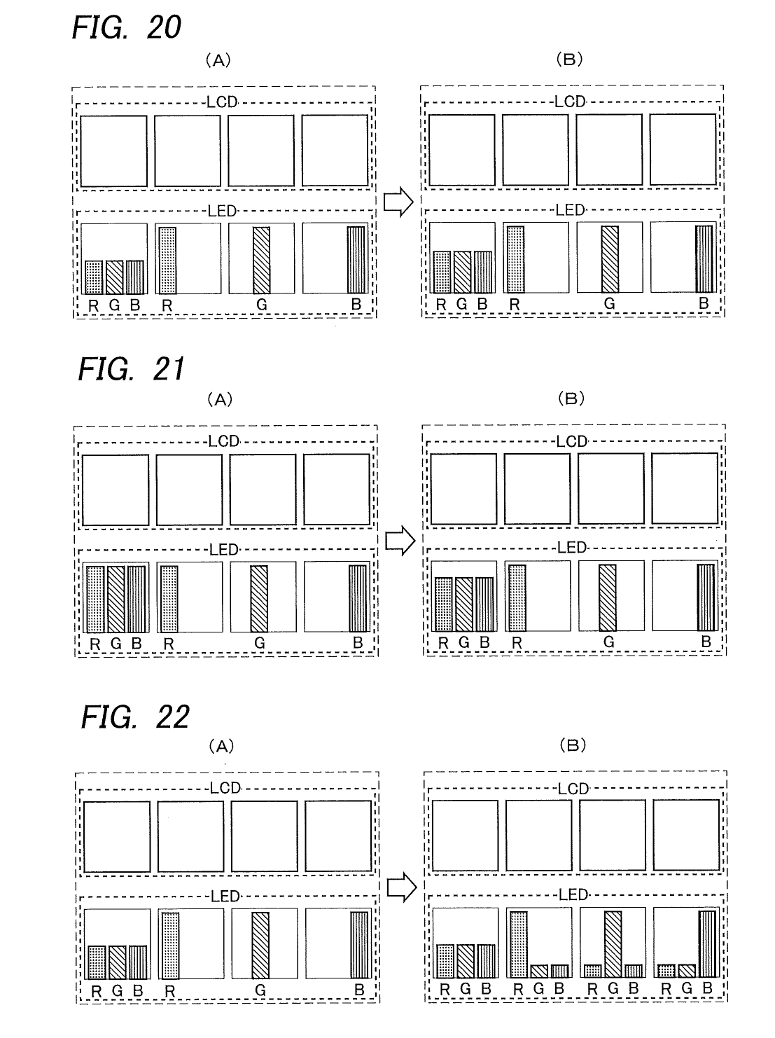

As in the first embodiment, it is assumed below that in a current image as shown in FIG. 13, a green area represented by (R, G, B)=(0, 1, 0) constitutes 4%, and a transparent color area constitutes 96%.

<2.3.1 First Operation Example (FIG. 20)>

In the present operation example, a housing-case-type transparent display in accordance with the four-subframe-configuration FS system operates under the following conditions:

(7a) the target selection coefficient is such that Kₜ=0.95;

(7b) the light source data initial values Ebₖ(where k=1 to 4) are as follows:

Eb₁=(0.5, 0.5, 0.5), Eb₂=(1, 0, 0), Eb₃=(0, 1, 0), and Eb₄=(0, 0, 1); and

(7c) the target color TCₖ (where k=1 to 4) is a transparent color or a simple color (i.e., a chromatic color), as shown below. Here, the target color candidate, which is the transparent color, is such that TCC=(1, 1, 1):

TC₁=(1, 1, 1), TC₂=(1, 0, 0), TC₃=(0, 1, 0), and TC₄=(0, 0, 1).

Under conditions (7a) to (7c), the light source data Eₖ in the present embodiment is generated as described below. Note that condition (7c) satisfies formulas (8) to (11) presupposing the housing-case-type transparent display (i.e., the first example).

In the present operation example, for the target color TC₁=(1, 1, 1), the target color display area proportion is such that TP₁=0.96, and the target color selection coefficient is such that Kₜ=0.95, hence TP₁>Kₜ. Accordingly, from formula (6), the light source data Eₖ is obtained as below.

R(E₁)=0.5+(1−0.5){(0.96−0.95)/(1−0.95)}=0.6

G(E₁)=0.5+(1−0.5){(0.96−0.95)/(1−0.95)}=0.6

B(E₁)=0.5+(1−0.5){(0.96−0.95)/(1−0.95)}=0.6

E₁=(0.6,0.6,0.6)

For the target colors TC₂=(1, 0, 0), TC₃=(0, 1, 0), and TC₄=(0, 0, 1), the respective target color display area proportions are TP₂=0, TP₃=0.04, and TP₄=0, and the target color selection coefficient is such that Kₜ=0.95, hence TP₂<Kₜ, TP₃<Kₜ, and TP₄<Kₜ. Accordingly, from formula (5), the light source data E₂, E₂, and E₃ are obtained as below.

E₂=Eb₂=(1, 0, 0), E₃=Eb₃=(0, 1, 0), and E₄=Eb₄=(0, 0, 1)

Note that the modulation data Cₖ for the display area of the transparent color (1, 1, 1) is 1 (where k=1 to 4).

As is evident from the above, in the present operation example, the operation is initially in a state as shown in (A) of FIG. 20, but under conditions (7a) to (7c), the operation is in a state as shown in (B) of FIG. 20. As shown in (B) of FIG. 20, during the first subframe period T₁, all of the red, green, and blue light sources emit light at 60% of a maximum intensity (in the initial state, light is emitted at 50% of the maximum intensity); during the second subframe period T₂, only the red light source emits light at the maximum intensity; during the third subframe period T₃, only the green light source emits light at the maximum intensity; and during the fourth subframe period T₄, only the blue light source emits light at the maximum intensity.

In the case where most (96%) of the area of an image to be displayed (i.e., a current image) is displayed in the transparent display mode, as shown in FIG. 13, color breakup in the transparent display area poses a problem more than does saturation in the color display area. In this regard, in the present embodiment, the light source state in the first operation example shown in (B) of FIG. 20 enhances the transparency of the transparent display area and reduces color breakup, but instead, the quality of additive color mixing is sacrificed (see (C) of FIG. 11).

<2.3.2 Second Operation Example (FIG. 21)>

In the present operation example, a stand-alone-type transparent display in accordance with the four-subframe-configuration FS system operates under the following conditions:

(8a) the target selection coefficient is such that Kₜ=0.95;

(8b) the light source data initial values Ebₖ(where k=1 to 4) are as follows:

Eb₁=(1, 1, 1), Eb₂=(1, 0, 0), Eb₃=(0, 1, 0), and Eb₄=(0, 0, 1); and

(8c) the target color TCₖ (where k=1 to 4) is a transparent color or a simple color (i.e., a chromatic color), as shown below. Here, the target color candidate, which is the transparent color, is such that TCC=(0, 0, 0):

TC₁=(0, 0, 0), TC₂=(1, 0, 0), TC₃=(0, 1, 0), and TC₄=(0, 0, 1).

Under conditions (8a) to (8c), the light source data Eₖ in the present embodiment is generated as described below. Note that condition (8c) satisfies formulas (12) to (15) presupposing the stand-alone-type transparent display (i.e., the second example).

In the present operation example, for the target color TC₁=(0, 0, 0), the target color display area proportion is such that TP₁=0.96, and the target color selection coefficient is such that K=0.95, hence TP₁>Kₜ. Accordingly, from formula (6), the light source data E₁ is obtained as below.

R(E₁)=1+(0−1){(0.96−0.95)/(1−0.95)}=0.8

G(E₁)=1+(0−1){(0.96−0.95)/(1−0.95)}=0.8

B(E₁)=1+(0−1){(0.96−0.95)/(1−0.95)}=0.8

E₁=(0.8,0.8,0.8)

For the target colors TC₂=(1, 0, 0), TC₃=(0, 1, 0), and TC₄=(0, 0, 1), the respective target color display area proportions are such that TP₂=0, TP₃=0.04, and TP₄=0, and the target color selection coefficient is such that K_{L}=0.95, hence TP₂<Kₜ, TP₃<Kₜ, and TP₄<Kₜ. Accordingly, from formula (5), the light source data E₂, E₃, and E₄ are obtained as below.

E₂=Eb₂=(1, 0, 0), E₃=Eb₃=(0, 1, 0), and E₄=Eb₄=(0, 0, 1)

Note that the modulation data Cₖ for the display area of the transparent color (0, 0, 0) is 1 (where k=1 to 4).

As is evident from the above, in the present operation example, the operation is initially in a state as shown in (A) of FIG. 21, but under conditions (8a) to (8c), the operation is in a state as shown in (B) of FIG. 21. As shown in (B) of FIG. 21, during the first subframe period T₁, all of the red, green, and blue light sources emit light at 80% of a maximum intensity (in the initial state, light is emitted at the maximum intensity); during the second subframe period T₂, only the red light source emits light at the maximum intensity; during the third subframe period T₃, only the green light source emits light at the maximum intensity; and during the fourth subframe period T₄, only the blue light source emits light at the maximum intensity.

In the case of the stand-alone-type transparent display, to allow background light to appear brighter, it is necessary to weaken light from the light source (see FIGS. 3 and 4), and therefore, in the case where most (96%) of the area of an image to be displayed (i.e., a current image) is displayed in the transparent display mode, as shown in FIG. 13, low transparency of the transparent display area poses a problem more than does the brightness of the color display area. In this regard, in the present embodiment, the light source state in the second operation example shown in (B) of FIG. 21 enhances the transparency of the transparent display area, but instead, the quality of additive color mixing is sacrificed (see (C) of FIG. 12).

<2.4 Variant>

Next, a variant of the second embodiment will be described. The present variant differs from the second embodiment in the target color determination processing for the target color TCₖ by the input data judgment portion, but the other features are the same as in the second embodiment. Accordingly, in the following, elements of the present embodiment that are the same as or correspond to the elements of the second embodiment are denoted by the same reference characters and any detailed descriptions thereof will be omitted.

In the present variant, as in the first and second embodiments, as a target color candidate TCC=(Rₜ, Gₜ, Bₜ), a transparent color that satisfies formulas (8) to (11) is provided in the case of the housing-case-type transparent display, and a transparent color that satisfies formulas (12) to (15) are provided in the case of the stand-alone-type transparent display. In the second embodiment, the transparent color which is the target color candidate TCC is determined as the target color TCₛ for the subframe period Tₛ corresponding to the light source data initial value Ebₛ for which saturation is minimum among all light source data initial values Eb₁ to Eb_{L}, and the light source data initial values Ebⱼ other than the light source data initial value Eb₃ are determined as the target colors TC₁ for their corresponding subframe periods Tⱼ (where 1≤j≤L and j≠s). In this regard, in the present variant, the transparent color which is the target color candidate TCC is determined as a target color TCₘ for a subframe period Tₘ corresponding to a light source data initial value Ebₘ for which saturation is maximum among all light source data initial values Eb₁ to Eb_{L}, and the light source data initial values Ebⱼ other than the light source data initial value Ebₘ, i.e., the light source data initial values Ebⱼ for which saturation is not maximum (including the light source data initial value Ebₛ for which saturation is minimum), are determined as target colors TCⱼ for their corresponding subframe periods Tⱼ (where 1≤j≤L and j≠m).

The variant as above renders it possible to inhibit color breakup while enhancing visible luminance of background light, i.e., transparency, in the transparent display state as well as maintaining as much simple-color saturation as possible.

Effects of the present variant will be described by way of an operation example below on the assumption, as in the second embodiment, that in a current image, a green area represented by (R, G, B)=(0, 1, 0) constitutes 4%, and a transparent color area constitutes 96%, as shown in FIG. 13.

In the present operation example, a housing-case-type transparent display in accordance with the four-subframe-configuration FS system operates under the following conditions:

(9a) the target selection coefficient is such that Kₜ=0.95;

(9b) the light source data initial values Ebₖ(where k=1 to 4) are as follows:

Eb₁=(0.5, 0.5, 0.5), Eb₂=(1, 0, 0), Eb₃=(0, 1, 0), and Eb₄=(0, 0, 1); and

(9c) the target color TCₖ (where k=1 to 4) is as below. Here, the target color candidate, which is the transparent color, is such that TCC=(1,1,1):

TC₁=(0.5, 0.5, 0.5), and TC₂=TC₃=TC₄=(1, 1, 1)

Under conditions (9a) to (9c), the light source data Eₖ in the present variant is generated as described below. Note that under condition (9c), the transparent color (1, 1, 1) satisfies formulas (8) to (12) presupposing the housing-case-type transparent display (i.e., the first example).

In the present operation example, for the target color TC₁=(0.5, 0.5, 0.5), the target color display area proportion is such that TP₁=0, and the target color selection coefficient is such that Kₜ=0.95, hence TP₁<Kₜ. Accordingly, from formula (5), the light source data E₁ is obtained as below.

E₁=Eb₁=(0.5, 0.5, 0.5)

Moreover, for the target color TC₂=TC₃=TC₄=(1, 1, 1), the target color display area proportion is such that TP₂=TP₃=TP₄=0.96, and the target color selection coefficient is such that Kₜ=0.95, hence TP₂=TP₃=TP₄>Kₜ. Accordingly, from formula (6), the R-, G-, and B-components of the light source data E₂ to E₄ are obtained as follows:

R(E₂)=1+(1−1){(0.96−0.95)/(1−0.95)}=1

G(E₂)=0+(1−0){(0.96−0.95)/(1−0.95)}=0.2

B(E₂)=0+(1−0){(0.96−0.95)/(1−0.95)}=0.2

R(E₃)=0+(1−0){(0.96−0.95)/(1−0.95)}=0.2

G(E₃)=1+(1−1){(0.96−0.95)/(1−0.95)}=1

B(E₃)=0+(1−0){(0.96−0.95)/(1−0.95)}=0.2

R(E₄)=0+(1−0){(0.96−0.95)/(1−0.95)}=0.2

G(E₄)=0+(1−0){(0.96−0.95)/(1−0.95)}=0.2

B(E₄)=1+(1−1){(0.96−0.95)/(1−0.95)}=1

Therefore, E₂=(1, 0.2, 0.2), E₃=(0.2, 1, 0.2), and E₄=(0.2, 0.2, 1). Note that the modulation data Cₖ for the display area of the transparent color (1, 1, 1) is 1 (where k=1 to 4).

As is evident from the above, in the present operation example, the operation is initially in a state as shown in (A) of FIG. 22, but under conditions (9a) to (9c), the operation is in a state as shown in (B) of FIG. 22. As shown in (B) of FIG. 22, during the first subframe period T₁, all of the red, green, and blue light sources emit light at 50% of a maximum intensity (as in the initial state ((A) of FIG. 22); during the second subframe period T₂, the red light source emits light at the maximum intensity, and the green and blue light sources emit light at 20% of the maximum intensity; during the third subframe period T₃, the green light source emits light at the maximum intensity, and the red and blue light sources emit light at 20% of the maximum intensity; and during the fourth subframe period T₄, the blue light source emits light at the maximum intensity, and the red and green light sources emit light at 20% of the maximum intensity.

In the case where most (96%) of the area of an image to be displayed (i.e., a current image) is displayed in the transparent display mode, as shown in FIG. 13, color breakup in the transparent display area poses a problem more than does saturation in the color display area. In this regard, in the present embodiment, the light source state in the operation example shown in (B) of FIG. 22 enhances the transparency of the transparent display area and reduces color breakup, but instead, saturation in the color display area decreases (see (C) of FIG. 11).

### 3. Variant

The present invention is not limited to the embodiments, and various modifications can be made without departing from the scope of the present invention.

For example, in each of the embodiments, a color image is displayed for each frame period by virtue of temporal additive color mixing in which for each of three subframe periods corresponding to three primary colors, or for each of four subframe periods corresponding to three primary colors and white, an image is displayed in a color assigned to the subframe period; the three primary colors used here are red, green, and blue, but other colors may be used for the three primary colors. Moreover, in addition to the three or four subframe periods, each frame period may include a subframe period during which an image is displayed in another color. Note that the number of subframe periods included in each frame period is not limited to three or four, so long as the number is plural.

While the present invention has been described above taking as an example the liquid crystal display device, the present invention is not limited to the liquid crystal display device and can also be applied to display devices other than the liquid crystal display device, so long as the display devices are field-sequential color image display devices which function as transparent displays.

### 4. Other

This application claims priority to Japanese Patent Application No. 2015-215905, filed Nov. 2, 2015 and titled “Color Image Display Device and Color Image Display Method”, the content of which is incorporated herein by reference.

### INDUSTRIAL APPLICABILITY

The present invention can be applied to color image display devices, such as liquid crystal display devices, which are capable of displaying color images by a field-sequential system while achieving display in a transparent display mode.

### DESCRIPTION OF THE REFERENCE CHARACTERS

10 liquid crystal display device
11 liquid crystal panel (spatial light modulation portion)
17 scanning signal line driver circuit
18 data signal line driver circuit
20 display control circuit
30 pixel forming portion
40 light source unit
100 image display portion (display portion)
101 housing case
102 liquid crystal panel
103 light source portion
106a liquid crystal panel
106b light guide
106c PDLC panel
106 display panel
107 light source portion
110 pixel array portion
120 light source portion
200 drive control portion
202 input data judgment portion
204 image memory
206 modulation data computation portion
208 initial value memory
210 light source driver portion
212 modulation data computation portion
214 spatial light modulation drive portion
BCT light source control signal
Dᵢₙ input signal (input data)
TCₖ target color (where k=1 to L)
TPₖ target color display area proportion (where k=1 to L)
Eₖ light source data (where k=1 to L)
Cₖ modulation data (where k=1 to L)
Rᵢₙ red image signal
Gᵢₙ green image signal
Bᵢₙ blue image signal
S_{w} white modulation signal
Sᵣ red modulation signal
S_{g} green modulation signal
S_{b} blue modulation signal
Tₖ k'th subframe period (where k=1 to L)

1. A color image display device capable of displaying a color image by a field-sequential system with a plurality of subframe periods being included in each frame period, as well as capable of achieving display in a transparent color with a display portion on which to form an image to be displayed being rendered in a transparent state in units of pixels, the device comprising:
a light source portion configured to be able to emit light in different colors during the respective subframe periods on the basis of preset initial light source data;
a spatial light modulation portion configured to transmit light derived from the light source portion therethrough;
a light source data computation portion configured to generate drive light source data by modifying the initial light source data on the basis of input data representing an image to be displayed, so as to increase transparency of a transparent display area, wherein the drive light source data designates a color and an intensity of light emitted by the light source portion for each of the subframe periods, and the transparent display area corresponds to a portion of the image to be displayed, the portion being to be displayed in the transparent color, and
a modulation data computation portion configured to generate drive modulation data designating transmittance of the spatial light modulation portion for each pixel of the image to be displayed, on the basis of the input data.

2. The color image display device according to claim 1, further comprising an input data judgment portion configured to obtain a transparent display area proportion on the basis of the input data, the transparent display area proportion representing a proportion of the transparent display area in the image to be displayed, wherein,
the light source data computation portion generates the drive light source data by modifying the initial light source data in accordance with the transparent display area proportion so as to enhance the transparency of the transparent display area.

3. The color image display device according to claim 1, further comprising an input data judgment portion configured to obtain a target color display area proportion for each target color on the basis of the input data, the target color display area proportion representing a proportion of a target color display area to be displayed in the target color in the image to be displayed, the target color being determined for each of the subframe periods on the basis of the initial light source data such that the target color for a subframe period corresponding to a color whose saturation is minimum or maximum among all colors of light respectively designated by the initial light source data for the subframe periods, is a transparent color and the target colors for the other subframe periods are colors of light respectively designated by the initial light source data for those other subframe periods, wherein,
the light source data computation portion generates the drive light source data by modifying the initial light source data such that the light emitted by the light source portion during each of the subframe periods approximates the light in the target color in accordance with the target color display area proportion.

4. The color image display device according to claim 3, wherein,
each frame period includes four subframe periods consisting of first through fourth subframe periods,
the light source portion includes a first, second, and third light sources respectively emitting light in three primary colors consisting of first, second, and third primary colors, and
the initial light source data is light source data for causing the first, second, and third light sources to emit light during the first subframe period, causing only the first light source to emit light during the second subframe period, causing only the second light source to emit light during the third subframe period, and causing only the third light source to emit light during the fourth subframe period.

5. The color image display device according to claim 4, wherein,
the display portion is configured such that the transparency of the transparent display area increases with an emission intensity of the light source portion, and
the light source data computation portion generates the drive light source data by modifying the initial light source data such that emission intensities of the first, second, and third light sources during the first subframe period increase in accordance with the transparent display area proportion.

6. The color image display device according to claim 4, wherein,
the display portion is configured such that the transparency of the transparent display area increases as an emission intensity of the light source portion decreases, and
the light source data computation portion generates the drive light source data by modifying the initial light source data such that emission intensities of the first, second, and third light sources during the first subframe period decrease in accordance with the transparent display area proportion.

7. The color image display device according to claim 1, further comprising an input data judgment portion configured to obtain a transparent display area proportion on the basis of the input data, the transparent display area proportion representing a proportion of the transparent display area in the image to be displayed, wherein,
the display portion is configured such that the transparency of the transparent display area increases with an emission intensity of the light source portion,
the light source portion includes a plurality of light sources respectively emitting light in different colors, and
the light source data computation portion generates the drive light source data by modifying the initial light source data in accordance with the transparent display area proportion such that an average intensity of light emitted by each of the light sources to form the image to be displayed, taken from among the subframe periods, becomes higher than an average emission intensity of the light source among the subframe periods, the average emission intensity being indicated by the initial light source data.

8. The color image display device according to claim 7, wherein,
each frame period consists of at least three subframe periods, including first, second, and third subframe periods,
the light source portion includes first, second, and third light sources respectively emitting light in different colors,
the initial light source data is light source data for causing only the first light source to emit light during the first subframe period, causing only the second light source to emit light during the second subframe period, and causing only the third light source to emit light during the third subframe period, and
the light source data computation portion generates the drive light source data by modifying the initial light source data in accordance with the transparent display area proportion such that the second and third light sources, along with the first light source, emit light during the first subframe period, the first and third light sources, along with the second light source, emit light during the second subframe period, and the first and second light sources, along with the third light source, emit light during the third subframe period.

9. The color image display device according to claim 1, further comprising an input data judgment portion configured to obtain a transparent display area proportion on the basis of the input data, the transparent display area proportion representing a proportion of the transparent display area in the image to be displayed, wherein,
the display portion is configured such that the transparency of the transparent display area increases as an emission intensity of the light source portion decreases,
the light source portion includes a plurality of light sources respectively emitting light in different colors, and
the light source data computation portion generates the drive light source data in accordance with the transparent display area proportion such that an average intensity of light emitted by each of the light sources to form the image to be displayed, taken from among the subframe periods, becomes lower than an average emission intensity of the light source among the subframe periods, the average emission intensity being indicated by the initial light source data.

10. The color image display device according to claim 9, wherein,
each frame period consists of at least three subframe periods, including first, second, and third subframe periods,
the light source portion includes first, second, and third light sources respectively emitting light in different colors,
the initial light source data is light source data for causing only the first light source to emit light during the first subframe period, causing only the second light source to emit light during the second subframe period, and causing only the third light source to emit light during the third subframe period, and
the light source data computation portion generates the drive light source data by modifying the initial light source data in accordance with the transparent display area proportion such that the first light source has a decreased emission intensity during the first subframe period, the second light source has a decreased emission intensity during the second subframe period, and the third light source has a decreased emission intensity during the third subframe period.

11. A color image display method for a display device capable of displaying a color image by a field-sequential system with a plurality of subframe periods being included in each frame period, as well as capable of achieving display in a transparent color with a display portion on which to form an image to be displayed being rendered in a transparent state in units of pixels, the method comprising:
a light source emission step of emitting light for forming the image to be displayed, from a light source portion configured to be able to emit light in different colors during the respective subframe periods on the basis of preset initial light source data;
a spatial light modulation step of changing transmittance through a spatial light modulation portion configured to transmit light derived from the light source portion therethrough, on the basis of input data representing an image to be displayed;
a light source data computation step of generating drive light source data by modifying the initial light source data on the basis of the input data so as to increase transparency of a transparent display area, wherein the drive light source data designates a color and an intensity of light emitted by the light source portion for each of the subframe periods, and the transparent display area corresponds to a portion of the image to be displayed, the portion being to be displayed in the transparent color; and
a modulation data computation step of generating drive modulation data on the basis of the input data, the drive modulation data designating the transmittance of the spatial light modulation portion for each pixel of the image to be displayed.

12. The color image display method according to claim 11, further comprising an input data judgement step of obtaining a transparent display area proportion on the basis of the input data, the transparent display area proportion representing a proportion of the transparent display area in the image to be displayed, wherein,
in the light source data computation step, the drive light source data is generated by modifying the initial light source data in accordance with the transparent display area proportion so as to enhance the transparency of the transparent display area.

13. The color image display method according to claim 11, further comprising an input data judgment step of obtaining a target color display area proportion for each target color on the basis of the input data, the target color display area proportion representing a proportion of a target color display area to be displayed in the target color in the image to be displayed, the target color being determined for each of the subframe periods on the basis of the initial light source data such that the target color for a subframe period corresponding to a color whose saturation is minimum or maximum among all colors of light respectively designated by the initial light source data for the subframe periods, is a transparent color and the target colors for the other subframe periods are colors of light respectively designated by the initial light source data for those other subframe periods, wherein,
in the light source data computation step, the drive light source data is generated by modifying the initial light source data such that the light emitted by the light source portion during each of the subframe periods approximates the light in the target color in accordance with the target color display area proportion.

14. The color image display method according to claim 11, further comprising an input data judgment step of obtaining a transparent display area proportion on the basis of the input data, the transparent display area proportion representing a proportion of the transparent display area in the image to be displayed, wherein,
the display portion is configured such that the transparency of the transparent display area increases with an emission intensity of the light source portion,
the light source portion includes a plurality of light sources respectively emitting light in different colors, and
in the light source data computation step, the drive light source data is generated by modifying the initial light source data in accordance with the transparent display area proportion such that an average intensity of light emitted by each of the light sources to form the image to be displayed, taken from among the subframe periods, becomes higher than an average emission intensity of the light source among the subframe periods, the average emission intensity being indicated by the initial light source data.

15. The color image display method according to claim 11, further comprising an input data judgment step of obtaining a transparent display area proportion on the basis of the input data, the transparent display area proportion representing a proportion of the transparent display area in the image to be displayed, wherein,
the display portion is configured such that the transparency of the transparent display area increases as an emission intensity of the light source portion decreases,
the light source portion includes a plurality of light sources respectively emitting light in different colors, and
in the light source data computation step, the drive light source data is generated in accordance with the transparent display area proportion such that an average intensity of light emitted by each of the light sources to form the image to be displayed, taken from among the subframe periods, becomes lower than an average emission intensity of the light source among the subframe periods, the average emission intensity being indicated by the initial light source data.
